(19) United States
(12) Patent Application Publication
(10) Pub. No.: US 2026/0275075 A1
(43) Pub. Date: Sep. 17, 2026

(54) COMPOSITION OF HEXANEDIOL GLYCIDYL ETHER AND/OR OLIGOMER THEREOF, CURABLE COMPOSITION, CURED PRODUCT

(71) Applicant: DIC Corporation, Tokyo (JP)

(72) Inventors: Hajime Suganuma, Sakura-shi (JP); Yoshinobu Sakurai, Sakura-shi (JP)

(73) Assignee: DIC Corporation, Tokyo (JP)

(21) Appl. No.: 19/167,879

(22) PCT Filed: Apr. 11, 2024
(86) PCT No.: PCT/JP2024/014628

§ 371 Date: Sep. 23, 2025

(30) Foreign Application Priority Data
Apr. 27, 2023 (JP) 2023-073461

(51) Int. Cl. C08K 5/1515; C08G 65/42

(52) U.S. Cl. CPC C08K 5/1515; C08G 65/42

(57) ABSTRACT

Provided is a composition of hexanediol glycidyl ether and/or an oligomer thereof capable of providing a cured product having excellent physical properties, and a curable composition and a cured product using the composition. The composition of the present invention relates to a composition of hexanediol glycidyl ether and/or an oligomer thereof containing hexanediol glycidyl ether and/or an oligomer thereof, wherein a total content of a compound having two or more secondary hydroxy groups in one molecule (A1) and a glycidyl ether compound (A2) of the compound (A1) is 100 mass ppm or less, and a total content of 6-hydroxyhexanal and a derivative thereof (B1) and a glycidyl ether compound (B2) of the compound (B1) is 1, 500 mass ppm or less.

### TECHNICAL FIELD

The present invention relates to a composition of hexanediol glycidyl ether and/or an oligomer thereof, a curable composition, and a cured product.

### BACKGROUND ART

Hexanediol glycidyl ether and/or an oligomer thereof (HDG) is synthesized by glycidyl-etherifying hexanediol (HD) as a raw material. Hexanediol diglycidyl ether as one HDG is synthesized by diglycidyl-etherifying HD as a raw material. In synthesizing HDG, a reaction between HDG and HD also occurs to synthesize an oligomer, such as a dimer or trimer, of HDG as a by-product.

HD serving as a raw material is produced in the form of an HD composition containing an impurity. A 1,6-hexanediol (1,6-HD) composition serving as one HD composition has conventionally been produced by esterifying a carboxylic acid mixture of adipic acid, which is produced by oxidizing cyclohexane as a petroleum chemical product, 6-hydroxycaproic acid, glutaric acid, and the like, and then hydrogenating the product, followed by distillation and purification.

Meanwhile, environmental awareness has been heightened in recent years, and hence a raw material derived from biomass resources is desired instead of a raw material derived from petroleum that affects global warming and with respect to 1,6-hexanediol, and attempts have also been made to produce a biomass-derived 1,6-hexanediol composition from the raw material derived from biomass resources by microorganisms. However, there is no marketed product. For example, PTLs 1 and 2 concern a method for producing a 1,6-hexanediol composition by using an enzyme, and disclose description of a production method by using enzymatic genetic information and metabolic pathway and purification.

### CITATION LIST

### Patent Literature

PTL 1: Japanese Unexamined Patent Application Publication No. 2020-114227
PTL 2: Japanese Patent No. 6680671

### SUMMARY OF INVENTION

### Technical Problem

The purity and performance of a composition of hexanediol glycidyl ether and/or an oligomer thereof are affected by the purity of an HD composition serving as a raw material and impurity. However, PTLs 1 and 2 disclose a method for producing a 1,6-hexanediol composition derived from biomass resources, which is environmentally responsible, but do not disclose an impurity contained in the 1,6-hexanediol composition.

The inventors of the present invention recognized that a 1,6-hexanediol composition obtained by the production method described in PTLs 1 and 2 contains large amounts of alicyclic diol, and 6-hydroxyhexanal and a derivative thereof as impurities.

In addition, the inventors recognized that a 1,6-hexanediol composition obtained by a production method through organic synthesis, in which a carboxylic acid mixture of adipic acid, which is produced by oxidizing cyclohexane as a petroleum chemical product, 6-hydroxycaproic acid, glutaric acid, and the like, is esterified and then hydrogenated, followed by distillation and purification, similarly contains large amounts of alicyclic diol, and 6-hydroxyhexanal and a derivative thereof as impurities.

When a compound having a hydroxy group, such as a compound having two or more secondary hydroxy groups in one molecule (A1) and 6-hydroxyhexanal and a derivative thereof (B1), is present in an HD composition, all or part of the hydroxy groups in the compound having a hydroxy group, such as the compound (A1) or the compound (B1), are glycidyl-etherified in a reaction for glycidyl-etherifying hexanediol, and a composition of hexanediol glycidyl ether and/or an oligomer thereof remains as an impurity. Further, the compound (A1) and the compound (B1) that are unreacted remain in the composition of hexanediol glycidyl ether and/or an oligomer thereof as impurities. As a result of the investigation made by the inventors, it was revealed that the impurities adversely affect the performance of the composition of hexanediol glycidyl ether and/or an oligomer thereof.

An object of the present invention is to provide a composition of hexanediol glycidyl ether and/or an oligomer thereof capable of providing a cured product having excellent physical properties, and a curable composition and a cured product using the composition.

### Solution to Problem

The inventors have intensively studied, and as a result, found that when each of the contents of the compound (A1) and a glycidyl ether compound of the compound (A1), and the compound (B1) and a glycidyl ether compound of the compound (B1) is set to a respective specific amount or less, a cured product having excellent physical properties can be provided. Thus, the present invention has been completed.

That is, an aspect (1) of the present invention relates to a composition of hexanediol glycidyl ether and/or an oligomer thereof containing hexanediol glycidyl ether and/or an oligomer thereof, in which a total content of a compound having two or more secondary hydroxy groups in one molecule (A1) and a glycidyl ether compound (A2) of the compound (A1) is 100 mass ppm or less, and a total content of 6-hydroxyhexanal and a derivative thereof (B1) and a glycidyl ether compound (B2) of the compound (B1) is 1,500 mass ppm or less.

An aspect (2) of the present invention relates to the composition of hexanediol glycidyl ether and/or an oligomer thereof according to the aspect (1) of the present invention in which the compound (A2) is at least one compound selected from the group consisting of a glycidyl ether of glucose (a compound represented by the following formula (A2-1)), a glycidyl ether of 1,4-cyclohexanediol (a compound represented by the following formula (A2-2)), a glycidyl ether of 1,2-cyclohexanediol (a compound represented by the following formula (A2-3)), and a glycidyl ether of 1,3-cyclohexanediol (a compound represented by the following formula (A2-4)):

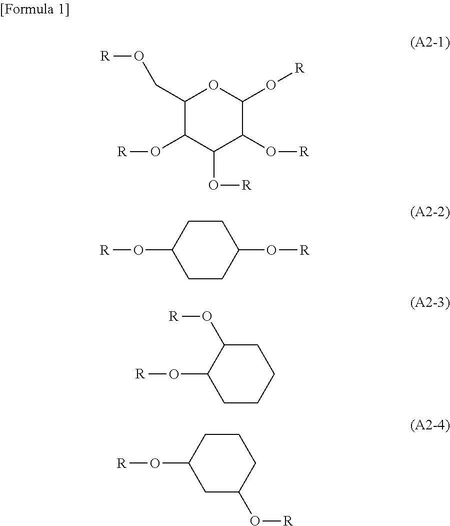

in the formulae (A2-1) to (A2-4), Rs are the same or different from each other, and each represent a hydrogen atom or a glycidyl group, provided that at least one R is a glycidyl group.

An aspect (3) of the present invention relates to the composition of hexanediol glycidyl ether and/or an oligomer thereof according to the aspect (1) or (2) of the present invention, in which the compound (B2) is at least one compound selected from the group consisting of compounds represented by the following formulae (B2-1) to (B2-7):

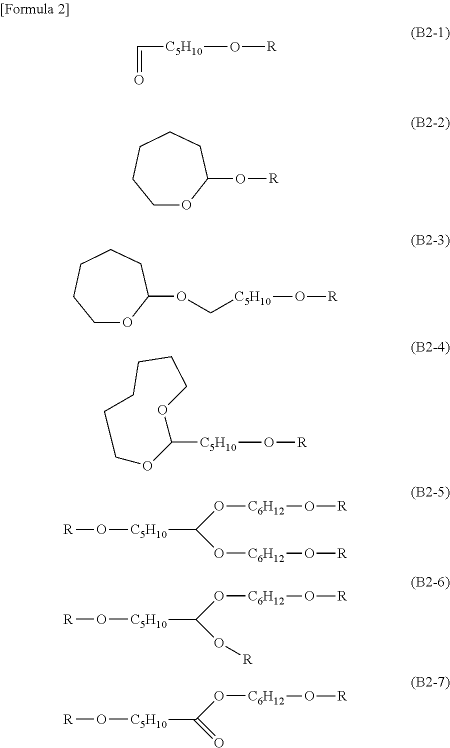

in the formulae (B2-1) to (B2-7), Rs are the same or different from each other, and each represent a hydrogen atom or a glycidyl group, provided that at least one R is a glycidyl group.

An aspect (4) of the present invention relates to the composition of hexanediol glycidyl ether and/or an oligomer thereof according to any one of the aspects (1) to (3) of the present invention, containing a glycidyl ether of glycerin (a compound represented by the following formula (C)):

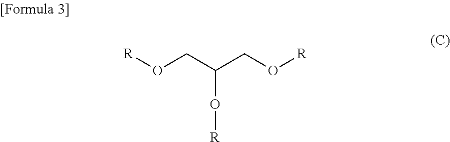

in the formula (C), Rs are the same or different from each other, and each represent a hydrogen atom or a glycidyl group, provided that at least one R is a glycidyl group.

An aspect (5) of the present invention relates to the composition of hexanediol glycidyl ether and/or an oligomer thereof according to any one of the aspects (1) to (4) of the present invention, in which the composition is prepared from a 1,6-hexanediol composition derived from biomass resources.

An aspect (6) of the present invention relates to a curable composition containing the composition of hexanediol glycidyl ether and/or an oligomer thereof according to any one of the aspects (1) to (5) of the present invention.

An aspect (7) of the present invention relates to the curable composition according to the aspect (6) of the present invention, containing an epoxy resin other than the composition of hexanediol glycidyl ether and/or an oligomer thereof.

An aspect (8) of the present invention relates to the curable composition according to the aspect (7) of the present invention, in which the epoxy resin other than the composition of hexanediol glycidyl ether and/or an oligomer thereof is a bisphenol F type epoxy resin.

An aspect (9) of the present invention relates to the curable composition according to the aspect (7) or (8) of the present invention, in which the epoxy resin other than the composition of hexanediol glycidyl ether and/or an oligomer thereof is a bisphenol A type epoxy resin.

An aspect (10) of the present invention relates to the curable composition according to any one of the aspects (6) to (9) of the present invention, containing a polyamine compound.

An aspect (11) of the present invention relates to the curable composition according to any one of the aspects (6) to (10) of the present invention, containing an acid anhydride.

An aspect (12) of the present invention relates to the curable composition according to any one of the aspects (6) to (11) of the present invention, containing a phenolic hydroxy group-containing resin.

An aspect (13) of the present invention relates to the curable composition according to any one of the aspects (6) to (12) of the present invention, in which the curable composition is used in at least one application selected from the group consisting of an ink, a coating, a paint, an adhesive, and a crack repair agent.

An aspect (14) of the present invention relates to a cured product obtained by curing the curable composition according to any one of the aspects (6) to (13) of the present invention.

### Advantageous Effects of Invention

The composition of hexanediol glycidyl ether and/or an oligomer thereof of the present invention contains hexanediol glycidyl ether and/or an oligomer thereof, in which the total content of a compound having two or more secondary hydroxy groups in one molecule (A1) and a glycidyl ether compound (A2) of the compound (A1) is 100 mass ppm or less, and the total content of 6-hydroxyhexanal and a derivative thereof (B1) and a glycidyl ether compound (B2) of the compound (B1) is 1, 500 mass ppm or less, and therefore a cured product having excellent physical properties can be provided.

### DESCRIPTION OF EMBODIMENTS

<Composition of Hexanediol Glycidyl Ether and/or Oligomer Thereof>

A composition of hexanediol glycidyl ether and/or an oligomer thereof of the present invention contains hexanediol glycidyl ether and/or an oligomer thereof, the total content of a compound having two or more secondary hydroxy groups in one molecule (A1) and a glycidyl ether compound (A2) of the compound (A1) is 100 mass ppm or less, and the total content of 6-hydroxyhexanal and a derivative thereof (B1) and a glycidyl ether compound (B2) of the compound (B1) is 1,500 mass ppm or less. Accordingly, the composition of hexanediol glycidyl ether and/or an oligomer thereof of the present invention can be suitably used as an epoxy resin (polymerizable diluent), and a cured product having excellent physical properties, specifically excellent tensile strength, hardness, compressive strength, and bending strength can be provided.

The reason that such a functional effect is exerted is not clear, but it is assumed as described below.

The compound (A1) and/or the compound (B1) does not have a glycidyl group, and hence the compounds do not contribute to a curing reaction. When the compounds are contained, a reduction in the transparency, tensile strength, hardness, compressive strength, and bending strength of the cured product is caused. The compound (A2) has reduced reactivity of the glycidyl group due to its rigid structure and the steric hindrance thereof, reducing the physical properties of the cured product. Glycidylation of the compound (A1) is originally difficult to promote due to its secondary hydroxy group, and the compound (A1) contains a large amount of a monofunctional glycidyl group and becomes a reaction terminator during curing, and hence a reduction in the physical properties is caused. The compounds (B2-1) to (B2-4) are monofunctional glycidyls, and reduce the physical properties of the cured product similarly. The compounds (B2-5) to (B2-6) have a large molecular weight, increase the viscosity of a curable composition, and cause a reduction in reactivity, and hence the physical properties of the cured product are reduced.

The composition of hexanediol glycidyl ether and/or an oligomer thereof of the present invention contains hexanediol glycidyl ether and/or an oligomer thereof, the total content of a compound having two or more secondary hydroxy groups in one molecule (A1) and a glycidyl ether compound (A2) of the compound (A1) is 100 mass ppm or less, and the total content of 6-hydroxyhexanal and a derivative thereof (B1) and a glycidyl ether compound (B2) of the compound (B1) is 1,500 mass ppm or less.

Hexanediol glycidyl ether and/or an oligomer thereof (HDG) is a compound represented by the following formula (HDG).

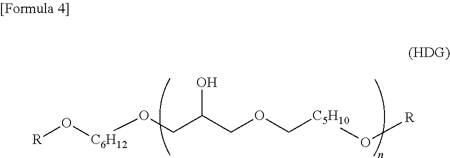

In the formula, Rs are the same or different from each other, and each represent a hydrogen atom or a glycidyl group, and n represents an integer of 0 or more, provided that at least one R is a glycidyl group.

In the formula (HDG), n represents an integer of 0 or more, but the upper limit thereof is preferably 5 or less, more preferably 4 or less, and still more preferably 3 or less.

The “secondary hydroxy group” as used herein means a hydroxy group in which a carbon atom to be bound to the hydroxy group is a secondary carbon atom.

The “glycidyl ether compound of a compound” as used herein means a glycidyl ether of the compound.

Examples of the hexanediol glycidyl ether include hexanediol monoglycidyl ether and hexanediol diglycidyl ether. The hexanediol glycidyl ethers may be used alone, or two or more kinds thereof may be used in combination. Of these, hexanediol diglycidyl ether is preferred since a cured product having more excellent physical properties is more suitably obtained.

Examples of an oligomer of the hexanediol glycidyl ether include a monoglycidyl of the hexanediol glycidyl ether and a diglycidyl of the hexanediol glycidyl ether. The oligomers may be used alone, or two or more kinds thereof may be used in combination. Of these, the diglycidyl of the hexanediol diglycidyl ether is preferred since a cured product having more excellent physical properties is more suitably obtained.

The hexanediol glycidyl ether and/or the oligomer thereof (HDG) generally contain a large amount of the hexanediol glycidyl ether and a small amount of the oligomer of the hexanediol glycidyl ether as a by-product. The content of the hexanediol glycidyl ether in 100 mass % of the hexanediol glycidyl ether and/or the oligomer thereof (HDG) is preferably 50 mass % or more, more preferably 60 mass % or more, and still more preferably 70 mass % or more, and may be 100 mass %.

The positions of a hydroxy group and/or a glycidyl ether group of the hexanediol glycidyl ether and/or the oligomer thereof are not particularly limited, and examples thereof include the 1,2-positions, 1,3-positions, 1,4-positions, 1,5-positions, 1,6-positions, 2,5-positions, 2,4-positions, 2,3-positions, and 3,4-positions of a hexanediol structural unit. Of these, the 1,6-position is preferred since a cured product having more excellent physical properties is more suitably obtained. Accordingly, the hexanediol glycidyl ether and/or the oligomer thereof is particularly preferably 1,6-hexanediol diglycidyl ether and/or an oligomer thereof.

The content of the hexanediol glycidyl ether and/or the oligomer thereof (the total content of the hexanediol glycidyl ether and the oligomer thereof) in the composition of hexanediol glycidyl ether and/or an oligomer thereof of the present invention is preferably 70.00 to 99.99 mass %, more preferably 80.00 to 99.99 mass %, and still more preferably 90.00 to 99.99 mass %. When the purity of the hexanediol glycidyl ether and/or the oligomer thereof is within the above-mentioned range while the total content of the compound (A1) and the compound (A2) and the total content of the compound (B1) and the compound (B2) are within the above-mentioned ranges, the effects of the present invention tend to be more suitably achieved.

The content of hexanediol glycidyl ether and/or an oligomer thereof as used herein is a value measured by gas chromatography/mass spectrometry (GC/MS).

The compound having two or more secondary hydroxy groups in one molecule (A1) is not particularly limited as long as it is a compound having two or more secondary hydroxy groups in one molecule, and examples thereof include aliphatic polyols typified by 2,3-butylene glycol, erythritol, threitol, arabitol, xylitol, ribitol, iditol, galactitol, sorbitol, mannitol, and volemitol; alicyclic polyols typified by 1,2-cyclohexanediol, 1,4-cyclohexanediol, glucose, fructose, inositol, and quercitol; and oligomers obtained by dehydration condensation of any combination of the compounds. The compound may include one or two or more of the compounds. Of these, the compound may be 1,2-cyclohexanediol, 1,3-cyclohexanediol, 1,4-cyclohexanediol, and glucose since they significantly affect the physical properties of a cured product.

The glycidyl ether compound (A2) of the compound (A1) is not particularly limited as long as it is a glycidyl ether of the compound (A1), and examples thereof include glycidyl ethers of aliphatic polyols typified by 2,3-butylene glycol, erythritol, threitol, arabitol, xylitol, ribitol, iditol, galactitol, sorbitol, mannitol, and volemitol; glycidyl ethers of alicyclic polyols typified by 1,2-cyclohexanediol, 1,4-cyclohexanediol, glucose, fructose, inositol, and quercitol; and glycidyl ethers of oligomers obtained by dehydration condensation of any combination of the aliphatic polyols and the alicyclic polyols. The compound may include one or two or more of these compounds. In the compound (A2), all or part of hydroxy groups of the compound (A1) are glycidyl-etherified.

Of these, due to a significant influence on the physical properties of a cured product, the compound may be at least one compound selected from the group consisting of a glycidyl ether of glucose (a compound represented by the following formula (A2-1)), a glycidyl ether of 1,4-cyclohexanediol (a compound represented by the following formula (A2-2)), a glycidyl ether of 1,2-cyclohexanediol (a compound represented by the following formula (A2-3)), and a glycidyl ether of 1,3-cyclohexanediol (a compound represented by the following formula (A2-4)), or may be at least one compound selected from the group consisting of a glycidyl ether of glucose (the compound represented by the following formula (A2-1) in which all Rs are a glycidyl group), a glycidyl ether of 1,4-cyclohexanediol (the compound represented by the following formula (A2-2) in which all Rs are a glycidyl group), a glycidyl ether of 1,2-cyclohexanediol (the compound represented by the following formula (A2-3) in which all Rs are a glycidyl group), and a glycidyl ether of 1,3-cyclohexanediol (the compound represented by the following formula (A2-4) in which all Rs are a glycidyl group).

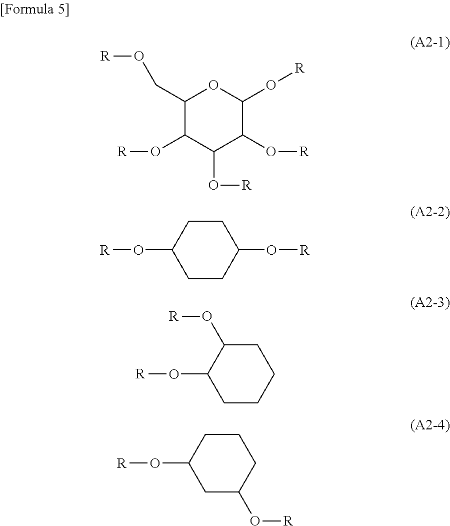

in the formulae (A2-1) to (A2-4), Rs are the same or different from each other, and each represent a hydrogen atom or a glycidyl group, provided that at least one R is a glycidyl group.

In the composition of hexanediol glycidyl ether and/or an oligomer thereof of the present invention, the total content of the compound having two or more secondary hydroxy groups in one molecule (A1) and the glycidyl ether compound (A2) of the compound (A1) (preferably the total content of 1,2-cyclohexanediol, 1,3-cyclohexanediol, 1,4-cyclohexanediol, glucose, and the compounds represented by the formulae (A2-1) to (A2-4)) is 100 mass ppm or less, preferably 50 mass ppm or less, more preferably 10 mass ppm or less, still more preferably 5 mass ppm or less, and particularly preferably 0 mass ppm (they are not contained). In this case, a cured product having excellent physical properties tends to be obtained.

The total content of the compound having two or more secondary hydroxy groups in one molecule (A1) and the glycidyl ether compound (A2) of the compound (A1) as used herein is a value measured by gas chromatography/mass spectrometry (GC/MS).

In the composition of hexanediol glycidyl ether and/or an oligomer thereof of the present invention, the total content of the 6-hydroxyhexanal and a derivative thereof (B1) and the glycidyl ether compound (B2) of the compound (B1) is 1,500 mass ppm or less.

The compound (B1) is 6-hydroxyhexanal or a derivative thereof.

The derivative of 6-hydroxyhexanal is not particularly limited as long as it is a derivative of 6-hydroxyhexanal (a compound represented by the following formula (B1-1)), and examples thereof include a cyclized product, an aldol condensate, a glycerin reaction product, and a hexanediol (HDO) reaction product. Specific examples include compounds represented by the following formulae (B1-2) to (B1-7). The derivative may include one or two or more of these compounds.

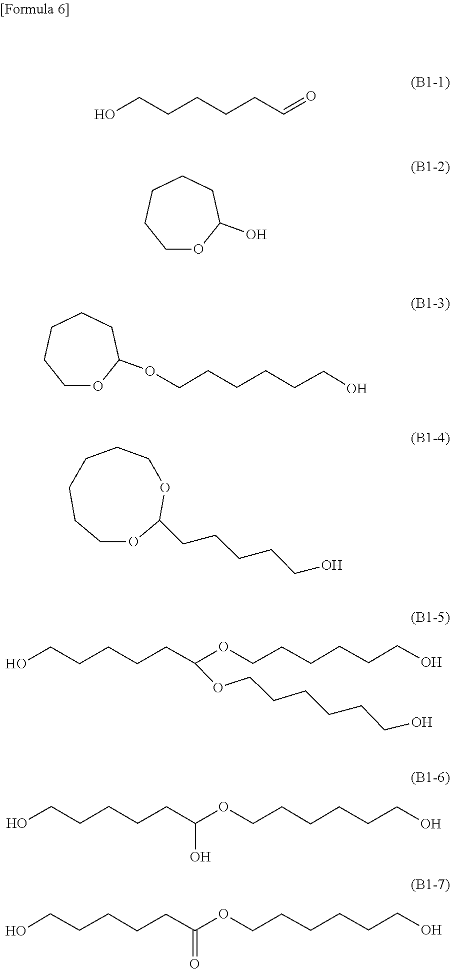

The 6-hydroxyhexanal or a derivative thereof (B1) may be 6-hydroxyhexanal due to a significant influence on the physical properties of a cured product.

The glycidyl ether compound (B2) of the compound (B1) is not particularly limited as long as it is a glycidyl ether of the compound (B1), and examples thereof include a glycidyl ether of 6-hydroxyhexanal, a glycidyl ether of a cyclized compound of 6-hydroxyhexanal, a glycidyl ether of an aldol condensate of 6-hydroxyhexanal, a glycidyl ether of a glycerin reaction product of 6-hydroxyhexanal, and a glycidyl ether of a hexanediol (HDO) reaction product of 6-hydroxyhexanal. The compound may include one or two or more of these compounds. The compound (B2) is obtained by glycidyl-etherifying all or part of hydroxy groups of the compound (B1).

Of these, due to a significant influence on the physical properties of a cured product, the compound may be at least one compound selected from the group consisting of the compounds represented by the following formulae (B2-1) to (B2-7), or at least one compound selected from the group consisting of the compounds represented by the following formulae (B2-1) to (B2-7), in which all Rs are a glycidyl group, or a compound represented by the following formula (B2-1).

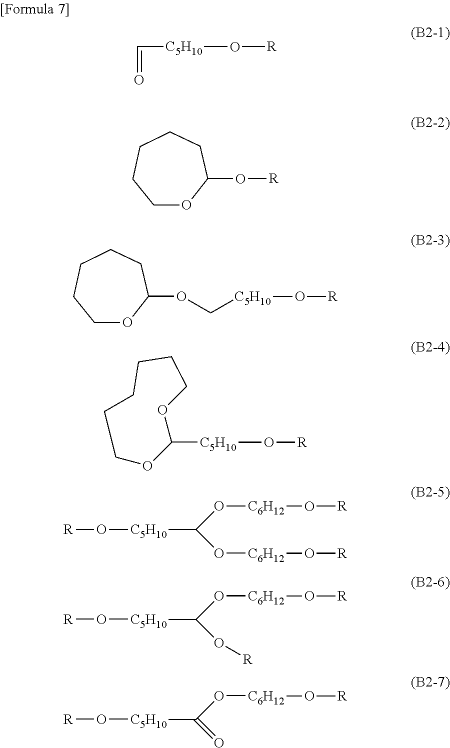

in the formulae (B2-1) to (B2-7), Rs are the same or different from each other, and each represent a hydrogen atom or a glycidyl group, provided that at least one R is a glycidyl group.

In the composition of hexanediol glycidyl ether and/or an oligomer thereof of the present invention, the total content of the 6-hydroxyhexanal and a derivative thereof (B1) and the glycidyl ether compound (B2) of the compound (B1) (preferably the content of 6-hydroxyhexanal and a glycidyl ether of 6-hydroxyhexanal) is 1,500 mass ppm or less, preferably 1,000 mass ppm or less, more preferably 500 mass ppm or less, still more preferably 200 mass ppm or less, and particularly preferably 0 mass ppm (they are not contained). In this case, a cured product having excellent physical properties tends to be obtained.

The total content of the 6-hydroxyhexanal and a derivative thereof (B1) and the glycidyl ether compound (B2) of the compound (B1) as used herein is a value measured by gas chromatography/mass spectrometry (GC/MS).

The composition of hexanediol glycidyl ether and/or an oligomer thereof of the present invention preferably contains a glycidyl ether of glycerin (a compound represented by the following formula (C)). In this case, a cured product having excellent physical properties (particularly tensile strength, hardness, compressive strength, and bending strength) tends to be more suitably obtained. This is presumed to be because satisfactory compatibility of a glycidyl ether of glycerin with hexanediol glycidyl ether and/or an oligomer thereof is due to ideal introduction of a high-cross-linking-density structure produced by a glycidyl ether of glycerin into a cured product. The compound represented by the following formula (C) may be used alone, or two or more kinds thereof may be used in combination.

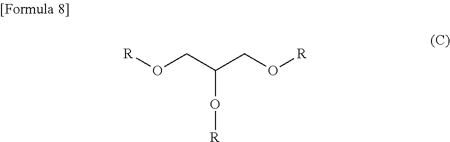

in the formula (C), Rs are the same or different from each other, and each represent a hydrogen atom or a glycidyl group, provided that at least one R is a glycidyl group.

In the formula (C), at least one R is a glycidyl group, at least two of Rs are preferably a glycidyl group, and all of Rs are more preferably a glycidyl group.

The content of the glycidyl ether of glycerin (preferably a triglycidyl ether of glycerin) in the composition of hexanediol glycidyl ether and/or an oligomer thereof of the present invention is preferably 0.1 to 50,000 ppm, more preferably 1 to 10,000 ppm, and still more preferably 5 to 10,000 ppm. When the content of the glycidyl ether of glycerin is 0.1 ppm or more, a resultant cured product tends to have an improved cross-linking density and excellent bending strength, elastic modulus, and tensile strength. When the content of the glycidyl ether of glycerin is 50,000 ppm or less, a resultant cured product tends to have excellent hardness, elastic modulus, and tensile strength.

The content of the glycidyl ether of glycerin as used herein is a value measured by gas chromatography/mass spectrometry (GC/MS).

The composition of hexanediol glycidyl ether and/or an oligomer thereof of the present invention may be produced, for example, by modifying one or both of two hydroxy groups of 1,6-hexanediol contained in a 1,6-hexanediol composition with epihalohydrin, such as epichlorohydrin, through a known method.

The composition of hexanediol glycidyl ether and/or an oligomer thereof of the present invention may be produced so that the total content of the compound (A1) and the compound (A2) and the total content of the compound (B1) and the compound (B2) are within the above-mentioned ranges. In order to produce the composition of hexanediol glycidyl ether and/or an oligomer thereof so that the total content of the compound (A1) and the compound (A2) and the total content of the compound (B1) and the compound (B2), contained in the composition of hexanediol glycidyl ether and/or an oligomer thereof, are within the above-mentioned ranges, for example, a hexanediol composition (preferably a 1,6-hexanediol composition) in which the total content of the compound (A1) is 100 mass ppm or less and the total content of the compound (B1) is 1, 500 mass ppm or less may be allowed as a raw material to react with epihalohydrin through a known method. Of course, the composition of hexanediol glycidyl ether and/or an oligomer thereof of the present invention may be produced by producing hexanediol glycidyl ether and/or the oligomer thereof including a large amount of impurity and then removing the impurity from the composition by purification.

The 1,6-hexanediol composition in which the total content of the compound (A1) is 100 mass ppm or less and the total content of the compound (B1) is 1, 500 mass ppm or less may be obtained by a production method based on organic synthesis in which a carboxylic acid mixture of adipic acid, which is produced by oxidizing cyclohexane as a petroleum chemical product, 6-hydroxycaproic acid, glutaric acid, and the like, is esterified and then hydrogenated, followed by distillation and purification, or by a production method from a raw material derived from biomass resources by using microorganisms. In order to remove the compound (A1) and the compound (B1) contained in the 1,6-hexanediol composition obtained by any production method, which is not limited, for example, step (2) to be described later can be performed to produce the 1,6-hexanediol composition in which the total content of the compound (A1) is 100 mass ppm or less and the total content of the compound (B1) is 1, 500 mass ppm or less.

As the 1,6-hexanediol composition in which the total content of the compound (A1) is 100 mass ppm or less and the total content of the compound (B1) is 1, 500 mass ppm or less, specifically, a 1,6-hexanediol composition obtained by the following environmentally benign production method (a method for producing a 1,6-hexanediol composition suitable for the present invention) (a 1,6-hexanediol composition derived from biomass resources) can be suitably used.

The method for producing a 1,6-hexanediol composition suitable for the present invention is an environmentally friendly production method in which carbon dioxide emissions can be decreased due to the production of the 1,6-hexanediol composition from a raw material derived from biomass resources.

Due to global warming caused by an increase in atmospheric carbon dioxide concentration and the occurrence of abnormal weather events worldwide, business activities that emphasize sustainability have been required. The composition of hexanediol glycidyl ether and/or an oligomer thereof of the present invention is prepared from the 1,6-hexanediol composition derived from biomass resources, and hence it may be a composition of hexanediol glycidyl ether and/or an oligomer thereof obtained by the environmentally friendly production method.

### <Method for Producing 1,6-Hexanediol Composition Suitable for the Present Invention>

A 1,6-hexanediol composition obtained by the method for producing a 1,6-hexanediol composition suitable for the present invention (also referred to as 1,6-hexanediol composition suitable for the present invention) will be first described.

In the 1,6-hexanediol composition suitable for the present invention, the total content of the compound having two or more secondary hydroxy groups in one molecule (A1) is 100 mass ppm or less.

Due to a significant influence on the physical properties of a cured product, the compound having two or more secondary hydroxy groups in one molecule (A1) may be 1,2-cyclohexanediol, 1,3-cyclohexanediol, 1,4-cyclohexanediol, or glucose.

In the 1,6-hexanediol composition suitable for the present invention, the total content of the compound having two or more secondary hydroxy groups in one molecule (A1) (preferably the total content of 1,2-cyclohexanediol, 1,3-cyclohexanediol, 1,4-cyclohexanediol, and glucose) is 100 mass ppm or less, preferably 50 mass ppm or less, more preferably 10 mass ppm or less, still more preferably 5 mass ppm or less, and particularly preferably 0 mass ppm (they are not contained). In this case, a cured product having excellent physical properties tends to be obtained.

The total content of the compound having two or more secondary hydroxy groups in one molecule (A1) as used herein is a value measured by gas chromatography/mass spectrometry (GC/MS).

In the 1,6-hexanediol composition suitable for the present invention, the total content of the 6-hydroxyhexanal and a derivative thereof (B1) is 1,500 mass ppm or less.

The 6-hydroxyhexanal and/or a derivative thereof (B1) may be 6-hydroxyhexanal due to a significant influence on the physical properties of a cured product.

In the 1,6-hexanediol composition suitable for the present invention, the total content of the 6-hydroxyhexanal and a derivative thereof (B1) (preferably the content of 6-hydroxyhexanal) is 1,500 mass ppm or less, preferably 1,000 mass ppm or less, more preferably 500 mass ppm or less, still more preferably 200 mass ppm or less, and particularly preferably 0 mass ppm (they are not contained). In this case, a cured product having excellent physical properties tends to be obtained.

The total content of the 6-hydroxyhexanal and a derivative thereof (B1) as used herein is a value measured by gas chromatography/mass spectrometry (GC/MS).

In the 1,6-hexanediol composition suitable for the present invention, the content of glycerin is preferably 0.1 to 50,000 ppm, more preferably 1 to 10,000 ppm, and still more preferably 5 to 10,000 ppm. When the content of glycerin is 0.1 ppm or more, a resultant cured product tends to have an improved cross-linking density and excellent bending strength, elastic modulus, and tensile strength. When the content of the glycerin is 50,000 ppm or less, a resultant cured product tends to have excellent hardness, elastic modulus, and tensile strength.

The content of glycerin as used herein is a value measured by gas chromatography/mass spectrometry (GC/MS).

In the 1,6-hexanediol composition suitable for the present invention, the content of 1,6-hexanediol is preferably 96.00 to 99.99 mass %, more preferably 98.00 to 99.99 mass %, and still more preferably 99.50 to 99.99 mass %. When the purity of the 1,6-hexanediol composition is within the above-mentioned range while the total content of the compound (A1) and the total content of the compound (B1) are within the above-mentioned ranges, the composition of hexanediol glycidyl ether and/or an oligomer thereof of the present invention tends to be more suitably obtained.

The content of 1,6-hexanediol as used herein is a value measured by gas chromatography/mass spectrometry (GC/MS).

The 1,6-hexanediol composition suitable for the present invention may be produced so that the total content of the compound (A1) and the total content of the compound (B1) are within the above-mentioned ranges.

As the 1,6-hexanediol composition suitable for the present invention, specifically, the 1,6-hexanediol composition obtained by the following environmentally benign production method (the method for producing a 1,6-hexanediol composition suitable for the present invention) (a 1,6-hexanediol composition derived from biomass resources) can be suitably used.

Next, the method for producing the 1,6-hexanediol composition suitable for the present invention will be described.

The method for producing the 1,6-hexanediol composition suitable for the present invention includes step (1) of producing the 1,6-hexanediol composition from 6-hydroxycaproic acid and/or a derivative thereof obtained from a raw material derived from biomass resources; and step (2) of purifying the 1,6-hexanediol composition obtained in step (1) by ion exchange and/or distillation.

### Step (1)

Step (1) is a step of producing the 1,6-hexanediol composition from 6-hydroxycaproic acid and/or a derivative thereof obtained from a raw material derived from biomass resources. Here, producing a 1,6-hexanediol composition from 6-hydroxycaproic acid and/or a derivative thereof obtained from a raw material derived from biomass resources means that a 1,6-hexanediol composition is produced via 6-hydroxycaproic acid and/or a derivative thereof from a raw material derived from biomass resources. Via 6-hydroxycaproic acid and/or a derivative thereof means that passing through 6-hydroxycaproic acid and/or a derivative thereof is sufficient, and may be, for example, in cells of microorganisms, a step of converting a raw material derived from biomass resources into the 1,6-hexanediol composition via 6-hydroxycaproic acid and/or a derivative thereof, a step of producing 6-hydroxycaproic acid and/or a derivative thereof from a raw material derived from biomass resources by microorganisms, and converting the 6-hydroxycaproic acid and/or a derivative thereof into the 1,6-hexanediol composition by microorganisms using a culture medium containing the 6-hydroxycaproic acid and/or a derivative thereof as it is, or a step of purifying the culture medium and converting the compound into the 1,6-hexanediol composition by microorganisms in different reaction vessels.

The derivative of 6-hydroxycaproic acid is not particularly limited as long as it is a derivative of 6-hydroxycaproic acid, and examples of the derivative of 6-hydroxycaproic acid include ester compounds, such as 6-hydroxy-hexanoyl-CoA that is a thioester of 6-hydroxycaproic acid, a cyclized compound of 6-hydroxycaproic acid, a condensate of 6-hydroxycaproic acid, and a condensate of 6-hydroxycaproic acid and 1,6-hexanediol. The compounds may be used alone, or two or more kinds thereof may be used in combination. Of these, 6-hydroxy-hexanoyl-CoA that is a thioester of 6-hydroxycaproic acid is preferred.

CoA as used herein means coenzyme A.

The 6-hydroxycaproic acid and/or a derivative thereof is preferably 6-hydroxycaproic acid or 6-hydroxy-hexanoyl-CoA, and more preferably 6-hydroxycaproic acid.

Step (1) is preferably a step of producing the 1,6-hexanediol composition under conditions of 70° C. or less, and more preferably a step of producing the 1,6-hexanediol composition under conditions of 50° C. or less. The lower limit of the temperature is not particularly limited, and 20° C. or more is preferred. By performing production at a relatively low temperature, carbon dioxide emissions during the production can be decreased, as well as a side reaction, such as circularization with dehydration, can be reduced, and the production of a by-product, such as a cyclic oligomer, can be suppressed. Accordingly, fogging, which is a problem of an automotive interior material and the like, is also suppressed. In addition, a packing inhibitor of a high molecular chain can be reduced to improve coating film physical properties.

Step (1) may be performed, for example, by using microorganisms capable of producing (biosynthesizing) 1,6-hexanediol. Examples of the microorganisms capable of producing 1,6-hexanediol include microorganisms described in Japanese Unexamined Patent Application Publication No. 2020-114227 and Japanese Patent No. 6680671. The microorganisms may be used alone, or two or more kinds thereof may be used in combination. The microorganisms capable of producing 1,6-hexanediol can be easily produced on the basis of the prior art described in the above publications by one skilled in the art, or acquired.

3-Oxopropionate and 3-hydroxypropanal are produced via metabolic pathways in microorganisms.

An example of production of 3-hydroxypropanal by microorganisms will be described. Glyceraldehyde 3-phosphate is produced from saccharides (pentoses and hexoses) via glycolytic metabolic pathways, such as a pentose phosphate pathway (PP pathway) in microorganisms, as described in FIG. 1 and the like of Japanese Patent No. 6680671. Similarly, glyceraldehyde 3-phosphate is produced from glycerin via metabolic pathways in microorganisms. From glyceraldehyde 3-phosphate, 3-hydroxypropanal is produced by a reaction that a plurality of enzymes of the microorganisms catalyzes. Alternatively, 3-hydroxypropanal is produced from glycerin in a single reaction with a diol dehydratase and/or a glycerol dehydratase.

An example of production of 3-oxopropionate by microorganisms will be described. 3-Phosphoglyceric acid and 2-phosphoglyceric acid are produced from saccharides (pentoses and hexoses) via glycolytic metabolic pathways, such as the Embden-Meyerhof pathway (EM pathway) in microorganisms, as described in FIG. 1 and the like of Japanese Patent No. 6680671. From 3-phosphoglyceric acid and 2-phosphoglyceric acid, glyceric acid is produced by utilizing enzymes described in Table 1 and the like of Japanese Patent No. 6680671 or a reverse reaction of glycerate kinase. 3-Oxopropionate is produced from glyceric acid with a diol dehydratase and/or a glycerol dehydratase. Further, 3-oxopropionate can also be produced from oxaloacetic acid that is a metabolic intermediate of a TCA cycle in a single reaction with keto acid decarboxylase. Oxaloacetic acid can also be produced from saccharides with phosphoenolpyruvate carboxylase and pyruvate carboxylase without passing through the TCA cycle.

1,6-Hexanediol is produced from 3-oxopropionate and 3-hydroxypropanal, which are produced via metabolic pathways in microorganisms, for example, by utilizing various pathways illustrated in FIGS. 2 to 5 of Japanese Patent No. 6680671.

Examples of the microorganisms capable of producing 1,6-hexanediol from 3-oxopropionate and 3-hydroxypropanal, that is, suitable examples of the microorganisms capable of producing 1,6-hexanediol include the following microorganisms.

Microorganisms having genes encoding ten enzymes in 1,6-hexanediol pathways including a 4,6-dihydroxy-2-oxo-hexanoate aldolase (2A in the drawing of Japanese Patent No. 6680671), a 4,6-dihydroxy-2-oxo-hexanoate 4-dehydratase (2B in the drawing of Japanese Patent No. 6680671), a 6-hydroxy-3,4-dehydro-2-oxohexanoate 3-reductase (2C in the drawing of Japanese Patent No. 6680671), a 6-hydroxy-2-oxohexanoate 2-reductase (2D in the drawing of Japanese Patent No. 6680671), a 2,6-dihydroxy-hexanoate CoA-transferase (2E in the drawing of Japanese Patent No. 6680671), a 2,6-dihydroxy-hexanoyl-CoA 2-dehydratase (2F in the drawing of Japanese Patent No. 6680671), a 6-hydroxy-2,3-dehydro-hexanoyl-CoA 2,3-reductase (2G in the drawing of Japanese Patent No. 6680671), a 6-hydroxyhexanoyl-CoA-transferase (4F3 in the drawing of Japanese Patent No. 6680671), a 6-hydroxyhexanoate 1-reductase (5R in the drawing of Japanese Patent No. 6680671), and a 6-hydroxyhexanal 1-reductase (5S in the drawing of Japanese Patent No. 6680671).

The microorganisms having genes encoding ten enzymes in the 1,6-hexanediol pathways are not particularly limited as long as they have genes encoding ten enzymes in the 1,6-hexanediol pathways. Examples thereof include prokaryotes and eukaryotes.

The microorganisms having genes encoding ten enzymes in the 1,6-hexanediol pathways may be recombinant microorganisms into which all and/or part of the genes (the enzymes) are introduced such that the microorganisms have the genes encoding ten enzymes in the 1,6-hexanediol pathways. For example, when the microorganisms to be used have only eight enzymes of the ten enzymes, genes encoding the remaining two enzymes have only to be introduced into the microorganisms. When the microorganisms to be used have only part of the ten enzymes, a single microorganism or a plurality of microorganisms having genes encoding the remaining enzymes may be used in combination.

Further, the microorganisms preferably have genes encoding a diol dehydratase and/or a glycerol dehydratase.

Here, the introduction of a gene can be performed by a known procedure.

Examples of prokaryotes include bacteria.

Examples of eukaryotes include yeasts and filamentous fungi.

Examples of bacteria include bacteria belonging to the family Enterobacteriaceae, coryneform bacteria, bacteria in the genus Bacillus, acetic acid bacteria, actinobacteria, and lactic acid bacteria.

Examples of the bacteria belonging to the family Enterobacteriaceae include bacteria belonging to the genus Escherichia, the genus Enterobacter, the genus Pantoea, the genus Klebsiella, the genus Serratia, the genus Erwinia, the genus Photorhabdus, the genus Providencia, the genus Salmonella, and the genus Morganella. Specifically, bacteria classified into the family Enterobacteriaceae by a classification method used in the database of National Center for Biotechnology Information (NCBI) (http://www.ncbi.nlm.nih.gov/Taxonomy/Browser/wwwtax.cgi?id=91347) can be used.

The bacteria in the genus Escherichia are not particularly limited, and examples thereof include bacteria classified into the genus Escherichia known to experts in microbiology. Examples of the bacteria in the genus Escherichia include those described in Neidhardt et al. (Backmann, B. J. 1996. Derivations and Genotypes of some mutant derivatives of Escherichia coli K-12, p. 2460 to 2488. Table 1. In F. D. Neidhardt (ed.), Escherichia coli and Salmonella Cellular and Molecular Biology/Second Edition, American Society for Microbiology Press, Washington, D.C.). Examples of the bacteria in the genus Escherichia include Escherichia coli. Examples of Escherichia coli include Escherichia coli K-12, such as Escherichia coli W3110 (ATCC 27325) and Escherichia coli MG1655 (ATCC 47076); Escherichia coli K5 (ATCC 23506); Escherichia coli B, such as Escherichia coli BL21 (DE3); and derivative strains thereof.

Examples of the bacteria in the genus Enterobacter include Enterobacter agglomerans and Enterobacter aerogenes. Examples of the bacteria in the genus Pantoea include Pantoea ananatis, Pantoea stewartii, Pantoea agglomerans, and Pantoea citrea. Examples of the bacteria in the genus Erwinia include Erwinia amylovora and Erwinia carotovora. Examples of the bacteria in the genus Klebsiella include Klebsiella planticola.

Examples of the coryneform bacteria include bacteria belonging to the genus Corynebacterium, the genus Brevibacterium, and the genus Microbacterium.

Specific examples of the coryneform bacteria include the following species:
Corynebacterium acetoacidophilum,
Corynebacterium acetoglutamicum,
Corynebacterium alkanolyticum,
Corynebacterium callunae,
Corynebacterium crenatum,
Corynebacterium glutamicum,
Corynebacterium lilium,
Corynebacterium melassecola,
Corynebacterium thermoaminogenes (Corynebacterium efficiens),
Corynebacterium herculis,
Brevibacterium divaricatum (Corynebacterium glutamicum),
Brevibacterium flavum (Corynebacterium glutamicum),
Brevibacterium immariophilum,
Brevibacterium lactofermentum (Corynebacterium glutamicum),
Brevibacterium roseum,
Brevibacterium saccharolyticum,
Brevibacterium thiogenitalis,
Corynebacterium ammoniagenes (Corynebacterium stationis),
Brevibacterium album,
Brevibacterium cerinum,
and Microbacterium ammoniaphilum.

Specific examples of the coryneform bacteria include the following strains:
Corynebacterium acetoacidophilum ATCC 13870
Corynebacterium acetoglutamicum ATCC 15806
Corynebacterium alkanolyticum ATCC 21511
Corynebacterium callunae ATCC 15991
Corynebacterium crenatum AS1.542
Corynebacterium glutamicum ATCC 13020, ATCC 13032, ATCC 13060, ATCC 13869, FERM BP-734
Corynebacterium lilium ATCC 15990
Corynebacterium melassecola ATCC 17965
Corynebacterium efficiens (Corynebacterium thermoaminogenes) AJ12340 (FERM BP-1539)
Corynebacterium herculis ATCC 13868
Brevibacterium divaricatum (Corynebacterium glutamicum) ATCC 14020
Brevibacterium flavum (Corynebacterium glutamicum) ATCC 13826, ATCC 14067, AJ12418 (FERM BP-2205)
Brevibacterium immariophilum ATCC 14068
Brevibacterium lactofermentum (Corynebacterium glutamicum) ATCC 13869
Brevibacterium roseum ATCC 13825
Brevibacterium saccharolyticum ATCC 14066
Brevibacterium thiogenitalis ATCC 19240
Corynebacterium ammoniagenes (Corynebacterium stationis) ATCC 6871, ATCC 6872
Brevibacterium album ATCC 15111
Brevibacterium cerinum ATCC 15112
Microbacterium ammoniaphilum ATCC 15354

Bacteria in the genus Corynebacterium include bacteria that were classified into the genus Brevibacterium, but have been integrated into the genus Corynebacterium (Int. J. Syst. Bacteriol., 41, 255 (1991)). Corynebacterium stationis includes a bacterium that was classified as Corynebacterium ammoniagenes, but has been reclassified as Corynebacterium stationis by 16S rRNA gene sequence analysis and the like (Int. J. Syst. Evol. Microbiol., 60, 874-879 (2010)).

Examples of the bacteria in the genus Bacillus include Bacillus subtilis, Bacillus amyloliquefaciens, Bacillus pumilus, Bacillus licheniformis, Bacillus megaterium, Bacillus brevis, Bacillus polymyxa, and Bacillus stearothermophilus. Specific examples of Bacillus subtilis include Bacillus subtilis 168 Marburg (ATCC 6051) and Bacillus subtilis PY79 (Plasmid, 1984, 12, 1-9). Specific examples of Bacillus amyloliquefaciens include Bacillus amyloliquefaciens T (ATCC 23842) and Bacillus amyloliquefaciens N (ATCC 23845).

Examples of acetic acid bacteria include bacteria belonging to the genus Gluconobacter, the genus Acetobacter, the genus Gluconacetobacter, the genus Acidicaldus, the genus Acidiphilium, the genus Acidisphaera, the genus Acidocella, the genus Acidomonas, the genus Asaia, the genus Belnapia, the genus Craurococcus, the genus Granulibacter, the genus Kozakia, the genus Leahibacter, the genus Muricoccus, the genus Neoasaia, the genus Oleomonas, the genus Paracraurococcus, the genus Rhodopila, the genus Roseococcus, the genus Rubritepida, the genus Saccharibacter, the genus Stella, the genus Swaminathania, the genus Teichococcus, and the genus Zavarzinia.

Specific examples of acetic acid bacteria include Gluconobacter oxydans, Acetobacter xylinum, Acidomonas methanolicus, Asaia bogorensis, Asaia krungthepensis, Belnapia moabensis, Gluconacetobacter xylinus, Granulibacter bethesdensis, Kozakia baliensis, and Oleomonas sagaranensis.

Examples of actinobacteria include bacteria belonging to the genus Actinomyces, the genus Mycobacterium, the genus Nocardia, the genus Streptomyces, the genus Actinoplanes, and the genus Rhodococcus.

Specific examples of actinobacteria include Streptomyces coelicolor, Streptomyces griseus, Streptomyces avermitilis, and Rhodococcus zopfii.

Examples of lactic acid bacteria include bacteria belonging to the genus Lacticaseibacillus, the genus Lactobacillus, the genus Ligilactobacillus, the genus Limosilactobacillus, the genus Liquorilactobacillus, the genus Lactiplantibacillus, the genus Streptococcus, the genus Lactococcus, and the genus Enterococcus.

Specific examples of lactic acid bacteria include Lacticaseibacillus casei, Lactobacillus gasseri, Lactobacillus acidophilus, Lactobacillus helveticus, Lactobacillus delbrueckii subsp. bulgaricus, Lactobacillus delbrueckii subsp. delbrueckii, Lactobacillus johnsonii, Ligilactobacillus salivarius, Limosilactobacillus fermentum, Liquorilactobacillus mali, Lactiplantibacillus plantarum, Streptococcus thermophilus, Lactococcus lactis subsp. lactis, Lactococcus lactis subsp. cremoris, Lactococcus plantarum, Lactococcus raffinolactis, Lactococcus cremoris, Enterococcus faecalis, and Enterococcus faecium.

Examples of bacteria other than the above-mentioned bacteria include bacteria belonging to the genus Pseudomonas, the genus Agrobacterium, the genus Alicyclobacillus, the genus Arthrobacter, the genus Azotobacter, the genus Chromatium, the genus Methylobacterium, the genus Rhodobacter, the genus Rhodopseudomonas, the genus Rhodospirillum, the genus Zymomonas, the genus Achromobacter, the genus Aerobacter, the genus Alcaligenes, the genus Erwinia, the genus Microbacterium, the genus Micrococcus, the genus Protaminobacter, the genus Proteus, the genus Sarcina, the genus Xanthomonas, the genus Aeromonas, the genus Flavobacterium, and the genus Rhizobium.

Examples of yeasts include yeasts belonging to the genus Saccharomyces, the genus Candida, the genus Pichia, the genus Schizosaccharomyces, the genus Kluyveromyces, the genus Rhodotorula, the genus Cryptococcus, the genus Torulopsis, the genus Hansenula, the genus Issatchenkia, and the genus Yarrowia.

Specific examples of yeasts include Saccharomyces cerevisiae, Candida utilis, Pichia pastoris, Hansenula polymorpha, and Schizosaccharomyces pombe.

Examples of filamentous fungi (mold) include fungi belonging to the genus Aspergillus, the genus Paecilomyces, the genus Penicillium, the genus Neurospora, the genus Trichoderma, the genus Fusarium, and the genus Chrysosporium.

Specific examples of filamentous fungi (mold) include Aspergillus oryzae, Paecilomyces saturatus, Paecilomyces divaricatus, and P. camemberti.

These strains are available, for example, from the American Type Culture Collection (address: 12301 Parklawn Drive, Rockville, Maryland 20852 P.O. Box 1549, Manassas, VA 20108, United States of America). That is, each of the strains is assigned a corresponding registration number, and can be obtained using the registration number (see http://www.atcc.org/). The registration numbers corresponding to the strains are described in the catalog of the American Type Culture Collection. For example, the strains are available from the depository institution where each strain was deposited.

The microorganisms may be used alone, or two or more kinds thereof may be used in combination. Of these, the prokaryotes are preferred, the bacteria are more preferred, the microorganisms belonging to the family Enterobacteriaceae are still more preferred, the microorganisms belonging to the genus Escherichia are particularly preferred, and Escherichia coli is most preferred. That is, the prokaryotes having genes encoding ten enzymes in the 1,6-hexanediol pathways are preferred, the bacteria having genes encoding ten enzymes in the 1,6-hexanediol pathways are more preferred, the microorganisms in the family Enterobacteriaceae having genes encoding ten enzymes in the 1,6-hexanediol pathways are still more preferred, the microorganisms belonging to the genus Escherichia having genes encoding ten enzymes in the 1,6-hexanediol pathways are particularly preferred, and Escherichia coli having genes encoding ten enzymes in the 1,6-hexanediol pathways is most preferred.

When the genes (enzymes) are exogenously introduced into microorganisms for expression,
it is preferable that the 4,6-dihydroxy-2-oxo-hexanoate aldolase be a 2,4-dihydroxyhept-2-ene-1,7-dioate aldolase to be encoded by a HpaI gene of Escherichia coli,
the 4,6-dihydroxy-2-oxo-hexanoate 4-dehydratase be a 2-oxo-hept-4-ene-1,7-dioate hydratase to be encoded by a HpcG/HpaH gene of Escherichia coli,
the 6-hydroxy-3,4-dehydro-2-oxohexanoate 3-reductase be a NADP-dependent alkenal reductase P1, GenBank Accession No. CAC01710.1, of Arabidopsis thaliana,
the 6-hydroxy-2-oxohexanoate 2-reductase be a D-2-hydroxy acid dehydrogenase to be encoded by a panE gene of Lactococcus lactis,
the 2,6-dihydroxy-hexanoate CoA-transferase and the 6-hydroxyhexanoyl-CoA-transferase be a glutaconate CoA-transferase to be encoded by a HadA gene of Clostridium difficile,
the 2,6-dihydroxy-hexanoyl-CoA 2-dehydratase be a 2-hydroxyisocaproyl-CoA dehydratase to be expressed by Clostridium difficile,
the 6-hydroxy-2,3-dehydro-hexanoyl-CoA 2,3-reductase be a trans-2-enoyl-CoA reductase, GenBank Accession No. AE017248, of Treponema denticola,
the 6-hydroxyhexanoate 1-reductase be ATP/NADPH-CAR, GenBank Accession No. AAR91681.1, of Nocardia iowensis, and/or
the 6-hydroxyhexanal 1-reductase be a 6-hydroxyhexanoate dehydrogenase, GenBank Accession No. AAN37489.1, of Rhodococcus.

(a) A step of converting a C₃ aldehyde and pyruvic acid into a C₆ β-hydroxyketone intermediate through aldol addition; and then (b) a step of converting the C₆ β-hydroxyketone intermediate into 1,6-hexanediol or a solvate thereof through an enzymatic step can be performed by using the microorganisms. Here, the converting preferably includes reduction of an enoyl or enoate, reduction of a ketone, reduction of an aldehyde, dehydration, formation of a thioester, reduction of a thioester, or a combination thereof.

In addition, it is preferable that a step of preparing a C₃ aldehyde and pyruvic acid from a supply source selected from glycerin, a pentose, a hexose, a phosphoglycerate, another carbon source, an intermediate of a glycolysis pathway, an intermediate of propanoic acid metabolism, or a combination thereof be further included.

Further, it is preferable that a C₃ aldehyde be obtained through a series of enzymatic steps and the enzymatic steps include dehydration of a diol.

More specifically, 1,6-hexanediol is produced by using the microorganisms from 3-oxopropionate and 3-hydroxypropanal, which are produced via metabolic pathways in the microorganisms, via the pathways 2A, 2B, 2C, 2D, 2E, 2F, 2G, 4F3, 5R, and 5S illustrated in FIGS. 2 and 5 of Japanese Patent No. 6680671. In this biosynthesis pathway, an enzymatic reaction proceeds to the pathway 2G to produce 6-hydroxy-hexanoyl-CoA, an enzymatic reaction of 4F3 then proceeds to produce 6-hydroxycaproic acid, an enzymatic reaction of 5R then proceeds to produce 6-hydroxyhexanal, and after that, an enzymatic reaction of 5S proceeds to produce 1,6-hexanediol.

Accordingly, step (1) can be performed by cultivating the microorganisms in a medium containing a raw material derived from biomass resources. That is, the 1,6-hexanediol composition can be produced from 6-hydroxycaproic acid and/or a derivative thereof obtained from the raw material derived from biomass resources by cultivating the microorganisms in a medium containing the raw material derived from biomass resources.

The raw material derived from biomass resources is not particularly limited, and examples thereof include carbon sources used in medium components, including saccharides, such as pentoses, such as xylose, xylulose, ribulose, arabinose, lyxose, and ribose, and hexoses, such as allose, altrose, glucose, mannose, gulose, idose, talose, galactose, fructose, psicose, sorbose, and tagatose, disaccharides, such as lactose, cellobiose, sucrose, and maltose, polysaccharides, such as starch, cellulose, agarose, and dextran, alcohols, such as sorbitol, ethanol, and glycerin, peptone, tryptone, and casamino acid; nitrogen sources used in medium components, including organic nitrogen compounds, such as peptone, triptone, casamino acid, a yeast extract, a meat extract, and corn steep liquor. The raw materials may be used alone, or two or more kinds thereof may be used in combination. Of these, the carbon source used as a medium component is preferred, and saccharides and alcohols are more preferred.

Of saccharides, a hexose is further preferred, and glucose is particularly preferred.

Of alcohols, glycerin is further preferred.

Accordingly, of the raw materials derived from biomass resources, glucose and glycerin are most preferred.

The medium is not particularly limited as long as it contains the raw material derived from biomass resources, and the medium may be a common medium containing the carbon source, the nitrogen source, an inorganic ion, and an organic nutrient source, if necessary, and may be appropriately prepared according to the microorganisms to be used. Of these, the carbon source is preferably contained as the raw material derived from biomass resources.

A carbon source other than the components is not particularly limited as long as the microorganisms can be used, and examples thereof include organic acids, such as fumaric acid, citric acid, acetic acid, and propionic acid, salts thereof, and hydrocarbon compounds, such as paraffin. The other carbon sources may be used alone, or two or more kinds thereof may be used in combination.

Examples of a nitrogen source other than the components include ammonium salts of inorganic salts, such as ammonium sulfate and ammonium chloride, ammonium salts of organic acids, such as ammonium fumarate and ammonium citrate, and nitrates, such as sodium nitrate and potassium nitrate. The other nitrogen sources may be used alone, or two or more kinds thereof may be used in combination.

For the medium, a nutrient source used in a common medium, such as a trace amount of metal salt, vitamins, or hormone, may be used. The nutrient sources may be used alone, or two or more kinds thereof may be used in combination. Of these, sodium and/or potassium are preferably contained as a trace amount of metal salt.

A culture condition is not particularly limited, and cultivation may be performed, for example, for about 4 to 140 hours while pH and temperature are approximately controlled within the range of pH of 3 to 11 and the range of temperature of 20 to 70° C. (more preferably 20 to 50° C.). The cultivation may be performed under an aerobic condition or an anaerobic condition and appropriately selected according to the microorganisms to be used. The aerobic condition is preferred.

When the microorganisms are cultivated in the medium containing the raw material derived from biomass resources as described above, the 1,6-hexanediol composition can be produced. The 1,6-hexanediol composition is present with the microorganisms in the medium, and hence the microorganisms may be removed from the medium, if necessary. A method for removing the microorganisms is not particularly limited, and may be performed, for example, by centrifugation and/or membrane separation.

Centrifugation is not particularly limited, and for example, continuous centrifugation with a continuous centrifuge may be used. Examples of the continuous centrifuge include a basket-type centrifuge, a disk-type centrifuge, and a nozzle-type centrifuge. The continuous centrifuges may be used alone, or two or more kinds thereof may be used in combination.

A membrane used in membrane separation is not particularly limited. Examples thereof include a membrane having a pore diameter of 10.0 μm or less, and specific examples include a microfiltration membrane, an ultrafiltration membrane, a nanofiltration membrane, and a reverse osmosis membrane. The membranes may be used alone, or two or more kinds thereof may be used in combination. The shape of the membrane is not particularly limited, and may be any shape, such as a flat membrane, a hollow fiber membrane, a spiral membrane, a tubular membrane, or a pleated membrane. A filtration mode is not particularly limited, any of dead-end filtration and tangential flow filtration is applicable, and tangential flow filtration is preferred.

### Step (2)

Step (2) is a step of purifying the 1,6-hexanediol composition obtained in step (1) by ion exchange and/or distillation. Step (2) is not particularly limited as long as it is a step of appropriately removing the 1,6-hexanediol composition obtained in step (1), for example, an impurity contained in a medium that contains the 1,6-hexanediol composition and has been subjected to removal of the microorganisms, by ion exchange and/or distillation. Step (2) is preferably a step of purifying the 1,6-hexanediol composition obtained in step (1) by ion exchange and distillation. As ion exchange, cation exchange and anion exchange are preferably performed, and cation exchange and anion exchange in this order are more preferably performed. By distillation, removal of water, removal of a component having a lower boiling point than 1,6-hexanediol, and removal of a component having a higher boiling point than 1,6-hexanediol are preferably performed, and removal of water, removal of a component having a lower boiling point than 1,6-hexanediol, and removal of a component having a higher boiling point than 1,6-hexanediol in this order are more preferably performed.

The 1,6-hexanediol composition that is obtained in step (1) and used in step (2) is not particularly limited as long as it is the 1,6-hexanediol composition obtained in step (1), and is preferably a liquid obtained by removing the microorganisms from the medium containing the 1,6-hexanediol composition obtained in step (1), and more preferably a liquid obtained by removing the microorganisms by subjecting the medium containing the 1,6-hexanediol composition obtained in step (1) to treatment of centrifugation and membrane separation.

Hereinafter, an example of step (2) will be described in detail.

### [Ion Exchange Step]

In an ion exchange step, the 1,6-hexanediol composition is obtained via the following steps (a) and (b) in turn.

Step (a): A step of bringing the 1,6-hexanediol composition obtained in step (1) into contact with a cation-exchange resin to obtain a 1,6-hexanediol composition A.

Step (b): A step of bringing the 1,6-hexanediol composition A obtained in step (a) into contact with an anion-exchange resin to obtain a 1,6-hexanediol composition B.

Examples of a component to be removed by contact with the cation-exchange resin in step (a) include metal cations and ammonium ions.

Examples of a component to be removed by contact with the anion-exchange resin in step (b) include chloride ions, sulfate ions, phosphate ions, and organic acids. The organic acids described here include the compound having two or more secondary hydroxy groups in one molecule (A1).

The treatment with an ion-exchange resin is not particularly limited, and treatment by a batch process or a column process is preferred.

### Step (a): Step of Removing Cation Contained in 1,6-Hexanediol Composition

In step (a), the 1,6-hexanediol composition is brought into contact with a cation-exchange resin to remove cations.

Examples of the cation-exchange resin used include, but not particularly limited to, a strongly acidic resin and a weakly acidic resin. In addition, examples include, but not particularly limited to, styrene-based, acrylic, and hydrogel-based resins. Further, examples include, but not particularly limited to, gel-type, porous, and highly porous resins. Examples of the form of the resin include, but not particularly limited to, powder, spherical, fibrous, and membrane forms.

### Step (b): Step of Removing Anion Contained in 1,6-Hexanediol Composition

In step (b), the 1,6-hexanediol composition is brought into contact with an anion-exchange resin to remove anions.

Examples of the anion-exchange resin used include, but not particularly limited to, a strongly basic resin and a weakly basic resin. In addition, examples include, but not particularly limited to, styrene-based, acrylic, and hydrogel-based resins. Further, examples include, but not particularly limited to, gel-type, porous, and highly porous resins. Examples of the form of the resin include, but not particularly limited to, powder, spherical, fibrous, and membrane forms.

In the above-mentioned description, a process of performing step (a) and step (b) in this order is described, but step (b) and step (a) in this order may be performed. That is, the 1,6-hexanediol composition obtained in step (1) may be brought into contact with the anion-exchange resin, and then brought into contact with the cation-exchange resin.

Step (a) and step (b) may be performed simultaneously. That is, the 1,6-hexanediol composition obtained in step (1) may be brought into contact with the cation-exchange resin and the anion-exchange resin simultaneously.

### [Distillation Step]

In distillation, the 1,6-hexanediol composition E is obtained via the following steps (c), (d), and (e) in turn. In order to further increase purity, purification is optionally performed in step (f).

Step (c): A step of removing water contained in a liquid containing the 1,6-hexanediol composition from the 1,6-hexanediol composition (e.g., the 1,6-hexanediol composition B) obtained in the ion exchange step to obtain a 1,6-hexanediol composition C.

Step (d): A step of removing a component having a lower boiling point than 1,6-hexanediol from the 1,6-hexanediol composition C obtained in step (c) to obtain a 1,6-hexanediol composition D.

Step (e): A step of removing a component having a higher boiling point than 1,6-hexanediol from the 1,6-hexanediol composition D obtained in step (d) to obtain a 1,6-hexanediol composition E.

Step (f): A step of distilling the 1,6-hexanediol composition E obtained in step (e) to obtain 1,6-hexanediol having a high purity.

Examples of the component having a lower boiling point than 1,6-hexanediol in step (d) include 1,3-propanediol, the compound having two or more secondary hydroxy groups in one molecule (A1), and the 6-hydroxyhexanal and/or a derivative thereof (B1).

Examples of the component having a higher boiling point than 1,6-hexanediol in step (e) include glycerin, the compound having two or more secondary hydroxy groups in one molecule (A1), and the 6-hydroxyhexanal and/or a derivative thereof (B1).

A distillation method is not particularly limited, but removal by continuous or batch distillation is preferred.

### Step (c): Step of Removing Water Contained in 1,6-Hexanediol Composition

In step (c), the 1,6-hexanediol composition obtained in the ion exchange step (e.g., the 1,6-hexanediol composition B) is heated to a temperature at which water is evaporated, and subjected to reduced pressure, if necessary, to remove water from the 1,6-hexanediol composition B.

Examples of an apparatus to be used include, but not particularly limited to, a continuous distillation column, a multiple-effect evaporator, a thin-layer evaporator, an evaporator, a batch distillation column, and a spray separation apparatus.

### Step (d): Step of Removing Component Having Lower Boiling Point than 1,6-Hexanediol

In step (d), the component having a lower boiling point than 1,6-hexanediol is removed from the 1,6-hexanediol composition C.

Step (d) is a step to be performed for both sufficiently removing the component having a low boiling point to obtain 1,6-hexanediol having a high purity and removing a trace amount of a coloring component. In this operation, the removal or decrease of the coloring component itself and the component having a lower boiling point than 1,6-hexanediol, such as a hydrogenated compound of the coloring component, is particularly performed.

In step (d), for example, distillation can be performed by a known procedure, such as atmospheric distillation, vacuum distillation, or pressurized distillation, with a known apparatus. Examples of an apparatus for removal include, but not particularly limited to, a continuous distillation column, a multiple-effect evaporator, a thin-layer evaporator, an evaporator, a batch distillation column, and a spray separation apparatus. An operation condition used in step (d) may be appropriately set in consideration of the composition of the 1,6-hexanediol composition C, a purity to be finally determined, and the like, and is not particularly limited.

### Step (e): Step of Removing Component Having Higher Boiling Point than 1,6-Hexanediol

In step (e), the component having a higher boiling point than 1,6-hexanediol is removed from the 1,6-hexanediol composition D obtained in step (d).

In step (e), the removal of the component having a higher boiling point than 1,6-hexanediol that is specific to a fermentation process of a nitrogen-containing component derived from an amino acid and a protein, a saccharide, a decomposed substance thereof, or the like, is performed.

Examples of an apparatus for removal include, but not particularly limited to, a continuous distillation column, a multiple-effect evaporator, a thin-layer evaporator, an evaporator, a batch distillation column, and a spray separation apparatus. An operation condition used in step (e) may be appropriately set in consideration of the composition of the 1,6-hexanediol composition D, a purity to be finally determined, and the like, and is not particularly limited.

### Step (f): Step of Obtaining 1,6-Hexanediol Composition Having Higher Purity

In step (f), the 1,6-hexanediol composition E obtained via the steps (c), (d), and (e) is purified to obtain a 1,6-hexanediol composition having a higher purity.

Examples of an apparatus for obtaining a 1,6-hexanediol composition having a higher purity include, but not particularly limited to, a continuous distillation column, a multiple-effect evaporator, a thin-layer evaporator, an evaporator, a batch distillation column, and a spray separation apparatus.

An operation condition used in step (f) may be appropriately set in consideration of the composition of a liquid to be purified, a purity to be finally determined, and the like, and is not particularly limited.

By performing step (e), and if necessary, step (f), the 1,6-hexanediol composition suitable for the present invention is obtained.

In the above-mentioned description, a process of performing the steps (c), (d), and (e) in this order is described, but the steps may be performed in a different order.

The method for producing a 1,6-hexanediol composition suitable for the present invention has only to include the steps (1) and (2), and may include another step other than the steps (1) and (2), in addition to the steps (1) and (2).

When step (2) is performed, the total content of the compound having two or more secondary hydroxy groups in one molecule (A1) and the total content of the 6-hydroxyhexanal and a derivative thereof (B1) are within the above-mentioned ranges. However, step (2) may be repeatedly performed so that the total content of the compound having two or more secondary hydroxy groups in one molecule (A1) and the total content of the 6-hydroxyhexanal and a derivative thereof (B1) are more suitably within the above-mentioned ranges. By repeating step (2), the total content of the compound having two or more secondary hydroxy groups in one molecule (A1) and the total content of 6-hydroxyhexanal and a derivative thereof (B1) can be decreased.

### <Curable Composition>

A curable composition of the present invention contains the composition of hexanediol glycidyl ether and/or an oligomer thereof of the present invention.

The content of the composition of hexanediol glycidyl ether and/or an oligomer thereof of the present invention in 100 mass % of the sum of an epoxy resin and a curing agent in the curable composition is preferably 1 to 60 mass %, more preferably 3 to 40 mass %, and still more preferably 5 to 30 mass %. In this case, a cured product having more excellent physical properties tends to be more suitably obtained.

In addition to the composition of hexanediol glycidyl ether and/or an oligomer thereof of the present invention, the curable composition of the present invention preferably contains an epoxy resin other than the composition of hexanediol glycidyl ether and/or an oligomer thereof of the present invention (also referred to as other epoxy resin). By using both the composition and the other epoxy resin in combination, a cured product having more excellent physical properties tends to be more suitably obtained. The other epoxy resin may be used alone, or two or more kinds thereof may be used in combination.

The other epoxy resin is not particularly limited as long as it is a compound having an epoxy group in the molecule, and examples thereof include bisphenol type or biphenol type epoxy resins, such as a bisphenol F type epoxy resin, a bisphenol A type epoxy resin, and a tetramethyl biphenol type epoxy resin; aliphatic polyol polyglycidyl ethers, such as butanediol diglycidyl ether, neopentyl glycol diglycidyl ether, trimethylolpropane triglycidyl ether, and glycerin triglycidyl ether; cyclic structure-containing polyglycidyl compounds, such as diglycidylaniline, resorcinol diglycidyl ether, and hydrogenated bisphenol A diglycidyl ether; cyclic structure-containing monofunctional glycidyl compounds, such as alkyl phenol monoglycidyl ether; and polyglycidyl ester compounds, such as neodecanoic acid glycidyl ester. Of these, since a cured product having more excellent physical properties is more suitably obtained, a bisphenol type or biphenol type epoxy resin is preferred, a bisphenol type epoxy resin is more preferred, and a bisphenol F type epoxy resin and a bisphenol A type epoxy resin are still more preferred.

The epoxy equivalent of the other epoxy resin is preferably 150 to 250 g/eq, and more preferably 160 to 200 g/eq. In this case, a cured product having more excellent physical properties tends to be more suitably obtained.

The epoxy equivalent of an epoxy resin as used herein is a value measured in accordance with JIS K7236:2001.

The content of the other epoxy resin in 100 mass % of the sum of an epoxy resin and a curing agent in the curable composition is preferably 10 to 90 mass %, more preferably 20 to 80 mass %, and still more preferably 30 to 70 mass %. In this case, a cured product having more excellent physical properties tends to be more suitably obtained.

The content of the composition of hexanediol glycidyl ether and/or an oligomer thereof of the present invention and the other epoxy resin in 100 mass % of the sum of an epoxy resin and a curing agent in the curable composition, that is, the content of an epoxy resin is preferably 30 to 95 mass %, more preferably 50 to 90 mass %, and still more preferably 60 to 80 mass %. In this case, a cured product having more excellent physical properties tends to be more suitably obtained.

The content of the composition of hexanediol glycidyl ether and/or an oligomer thereof of the present invention in 100 mass % of an epoxy resin is preferably 5 to 70 mass %, more preferably 10 to 50 mass %, and still more preferably 10 to 30 mass %. In this case, a cured product having more excellent physical properties tends to be more suitably obtained.

The curable composition of the present invention preferably contains a curing agent in addition to the composition of hexanediol glycidyl ether and/or an oligomer thereof of the present invention, and more preferably contains the other epoxy resin and a curing agent in addition to the composition of hexanediol glycidyl ether and/or an oligomer thereof of the present invention. In this case, a cured product having more excellent physical properties tends to be more suitably obtained.

The curing agent is not particularly limited as long as it is a curing agent capable of curing an epoxy resin, and examples thereof include a polyamine compound, an amide compound, an acid anhydride, a phenolic hydroxy group-containing resin, a phosphorus compound, an imidazole compound, an imidazoline compound, a urea compound, an organic acid metal salt, a Lewis acid, and an amine complex salt. The curing agents may be used alone, or two or more kinds thereof may be used in combination. Of these, since a cured product having more excellent physical properties is more suitably obtained, at least one curing agent selected from the group consisting of a polyamine compound, an acid anhydride, and a phenolic hydroxy group-containing resin is preferred, and a polyamine compound is more preferred.

Examples of the polyamine compound include aliphatic amine compounds, such as trimethylenediamine, ethylenediamine, N, N,N′, N′-tetramethylethylenediamine, pentamethyldiethylenetriamine, triethylenediamine, dipropylenediamine, N,N,N′,N′-tetramethylpropylenediamine, tetramethylenediamine, pentanediamine, hexamethylenediamine, trimethylhexamethylenediamine, N,N,N′,N′-tetramethylhexamethylenediamine, N, N-dimethylcyclohexylamine, diethylenetriamine, triethylenetetramine, tetraethylenepentamine, dimethylaminopropylamine, diethylaminopropylamine, dibutylaminopropylamine, 1,4-diazabicyclo[2,2,2]octane (triethylenediamine), polyoxyethylenediamine, polyoxypropylenediamine, bis(2-dimethylaminoethyl) ether, dimethylaminoethoxyethanol, triethanolamine, and dimethylaminohexanol; alicyclic and heterocyclic amine compounds, such as piperidine, piperazine, menthanediamine, isophoronediamine, methylmorpholine, ethylmorpholine, N,N′,N″-tris(dimethylaminopropyl) hexahydro-s-triazine, a 3,9-bis(3-aminopropyl)-2, 4,8,10-tetraoxaspiro[5,5]undecane adduct, N-aminoethylpiperazine, trimethylaminoethylpiperazine, bis(4-aminocyclohexyl) methane, N,N′-dimethylpiperazine, and 1,8-diazabicyclo-[5.4.0]-undecene (DBU); aromatic amine compounds, such as o-phenylenediamine, m-phenylenediamine, p-phenylenediamine, diaminodiphenylmethane, diaminodiphenyl sulfone, benzylmethylamine, dimethylbenzylamine, m-xylenediamine, pyridine, picoline, and α-methylbenzylmethylamine; and modified amine compounds, such as an epoxy compound-added polyamine, a polyamine obtained by Michael addition, a polyamine obtained by Mannich addition, a thiourea-added polyamine, a ketone-capped polyamine, dicyandiamide, guanidine, an organic acid hydrazide, diaminomaleonitrile, amineimide, a boron trifluoride-piperidine complex, and a boron trifluoride-monoethylamine complex.

Examples of the amide compounds include dicyandiamide and polyamidoamines. Examples of the polyamidoamines include polyamidoamines obtained by a reaction of an aliphatic dicarboxylic acid such as succinic acid, glutaric acid, adipic acid, pimelic acid, suberic acid, or azelaic acid, or a carboxylic acid compound such as a fatty acid or a dimer acid with an aliphatic polyamine or a polyamine having a polyoxyalkylene chain.

Examples of the acid anhydrides include phthalic anhydride, trimellitic anhydride, pyromellitic anhydride, maleic anhydride, tetrahydrophthalic anhydride, methyltetrahydrophthalic anhydride, methyl nadic anhydride, hexahydrophthalic anhydride, and methylhexahydrophthalic anhydride.

Examples of the phenolic hydroxy group-containing resins include polyhydric phenol compounds, such as a phenol novolac resin, a cresol novolac resin, an aromatic hydrocarbon formaldehyde resin-modified phenolic resin, a dicyclopentadiene phenol-added resin, a phenol aralkyl resin (xylok resin), a naphthol aralkyl resin, a trimethylolmethane resin, a tetraphenylolethane resin, a naphthol novolac resin, a naphthol-phenol co-condensed novolac resin, a naphthol-cresol co-condensed novolac resin, a biphenyl-modified phenolic resin (a polyhydric phenol compound having a phenolic nucleus linked through a bismethylene group), a biphenyl-modified naphthol resin (a polyhydric naphthol compound having a phenolic nucleus linked through a bismethylene group), an aminotriazine-modified phenolic resin (a polyhydric phenol compound having a phenolic nucleus linked through melamine, benzoguanamine, or the like), and an alkoxy group-containing aromatic ring-modified novolac resin (a polyhydric phenol compound in which a phenolic nucleus and an alkoxy group-containing aromatic ring are linked through formaldehyde).

Examples of the phosphorus compounds include alkyl phosphines such as ethylphosphine and butylphosphine, primary phosphines such as phenylphosphine; dialkyl phosphines such as dimethylphosphine and dipropylphosphine; secondary phosphines such as diphenylphosphine and methylethylphosphine; and tertiary phosphines such as trimethylphosphine, triethylphosphine, and triphenylphosphine.

Examples of the imidazole compounds include imidazole, 1-methylimidazole, 2-methylimidazole, 3-methylimidazole, 4-methylimidazole, 5-methylimidazole, 1-ethylimidazole, 2-ethylimidazole, 3-ethylimidazole, 4-ethylimidazole, 5-ethylimidazole, 1-n-propylimidazole, 2-n-propylimidazole, 1-isopropylimidazole, 2-isopropylimidazole, 1-n-butylimidazole, 2-n-butylimidazole, 1-isobutylimidazole, 2-isobutylimidazole, 2-undecyl-1H-imidazole, 2-heptadecyl-1H-imidazole, 1,2-dimethylimidazole, 1,3-dimethylimidazole, 2,4-dimethylimidazole, 2-ethyl-4-methylimidazole, 1-phenylimidazole, 2-phenyl-1H-imidazole, 4-methyl-2-phenyl-1H-imidazole, 2-phenyl-4-methylimidazole, 1-benzyl-2-methylimidazole, 1-benzyl-2-phenylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, a 2-phenylimidazole isocyanuric acid adduct, a 2-methylimidazole isocyanuric acid adduct, 2-phenyl-4,5-dihydroxymethylimidazole, 2-phenyl-4-methyl-5-hydroxymethylimidazole, 1-cyanoethyl-2-phenyl-4,5-di(2-cyanoethoxy)methylimidazole, 1-dodecyl-2-methyl-3-benzylimidazolium chloride, and 1-benzyl-2-phenylimidazole hydrochloride.

Examples of the imidazoline compounds include 2-methylimidazoline and 2-phenylimidazoline.

Examples of the urea compounds include p-chlorophenyl-N, N-dimethyl urea, 3-phenyl-1,1-dimethyl urea, 3-(3,4-dichlorophenyl)-N, N-dimethyl urea, and N-(3-chloro-4-methylphenyl)-N′,N′-dimethyl urea.

The curing agent is preferably blended in a proportion of an active hydrogen group of the curing agent of 0.1 to 3.0 mol, more preferably 0.5 to 2.0 mol, and still more preferably 0.7 to 1.2 mol, based on 1 mol of the epoxy group of the epoxy resin contained in the curable composition. By setting the amount of the curing agent to the above-mentioned amount, a cured product having more excellent physical properties tends to be more suitably obtained.

For the curable composition of the present invention, a variety of additives, such as a curing accelerator, a filler, an ultraviolet absorber, a pigment, a dye, a thickener, a low-shrinkage agent, an antiaging agent, a plasticizer, an aggregate, a flame retardant, a stabilizer, a fiber-reinforced material, an organic solvent, an antistat, an antifoaming agent, a viscosity modifier, an antioxidant, a leveling agent, a dispersant, or a wax may be used in addition to the above-mentioned components within the range that does not impair the effects of the present invention. The additives may be used alone, or two or more kinds thereof may be used in combination.

The curable composition of the present invention is used in applications, such as an ink, a coating, a paint, an adhesive, and a crack repair agent. Of these, the curable composition is preferably used in at least one application selected from the group consisting of an ink, a coating, a paint, an adhesive, and a crack repair agent, and more preferably used in at least one application selected from the group consisting of a paint, an adhesive, and a crack repair agent. When the curable composition of the present invention is used as a coating or a paint, the workability at a low temperature is satisfactory, and the compressive strength is also satisfactory. Accordingly, the curable composition can be suitably used as a coating or a paint for floors or roads. A crack repair agent is preferably a repair agent for repairing cracks of concrete or mortar.

An ink of the present invention is formed of the curable composition of the present invention. A coating of the present invention is formed of the curable composition of the present invention. A paint of the present invention is formed of the curable composition of the present invention. An adhesive of the present invention is formed of the curable composition of the present invention. A crack repair agent of the present invention is formed of the curable composition of the present invention.

When the curable composition of the present invention is used as an ink, a method in which the components are blended and stirred and mixed with a mixer or the like, and milled with a dispersing machine, such as a three-roll mill or a bead mill is exemplified. After printing with the obtained ink on various substrates, the ink can be appropriately heated to form a cured coating film.

Examples of a printing method with the ink include offset lithographic printing, relief printing, gravure printing, gravure offset printing, flexographic printing, and screen printing.

When the curable composition of the present invention is used as a coating or a paint, for example, a resin composition (paste) obtained by sufficiently kneading and uniformly dispersing the components with an apparatus, such as a mixer or a ball mill, may be prepared, and adjusted using an organic solvent or the like so as to have a desired viscosity. The obtained resin composition can be applied to various substrates by various kinds of coating methods. Moreover, the obtained resin composition can be applied to various substrates and then appropriately heated to form a cured coating film.

Examples of the coating methods include coating methods, such as a gravure coater, a knife coater, a roll coater, a comma coater, a spin coater, a bar coater, brush coating, dipping coating, and spray coating.

When the curable composition of the present invention is used as an adhesive, for example, a resin composition (paste) obtained by sufficiently kneading and uniformly dispersing the components with an apparatus, such as a mixer or a ball mill, may be prepared, and adjusted using an organic solvent or the like so as to have a desired viscosity. Moreover, the obtained resin composition can be applied to various substrates and then appropriately heated to achieve bonding to the substrates. Examples of coating methods include the same methods as those used as the coating or the paint.

A cured product of the present invention is obtained by curing the curable composition of the present invention. For example, the curable composition of the present invention is applied to a substrate to form a layer of the resin composition on the substrate, and the layer of the resin composition is appropriately heated, resulting in curing. Thus, a cured layer may be formed as a cured product. Here, for the resin composition prepared according to the above-mentioned applications, a coating method and a curing method according to the adapted applications may be appropriately adopted.

The expression “to” as used herein means a value before the expression “to” or more and a value after the expression “to” or less. When a plurality of numerical value ranges with respect to certain properties are disclosed by the expression “to” in the description, any combination of the upper limit and the lower limit in each of the numerical value ranges may also be used. For example, when two numerical value ranges of 0.001 to 500 mass ppm and 0.05 to 250 mass ppm are disclosed with respect to the content of a compound, the numerical value ranges mean that numerical value ranges of 0.001 to 250 mass ppm and 0.05 to 500 mass ppm are also disclosed in addition to 0.001 to 500 mass ppm and 0.05 to 250 mass ppm.

### EXAMPLES

Hereinafter, the present invention will be specifically described by Examples and Comparative Examples, but the present invention is not limited to the examples.

### (Production Example 1) (Construction of Recombinant Escherichia coli)

A plasmid A in which glycerol dehydratase α-, β-, and γ-subunits derived from Citrobacter freundii and a dehydratase reactivator were introduced into BamHI and HindIII restriction enzyme recognition sites of pACYC184 (Nippon Gene Co., Ltd.) was constructed.

A plasmid B in which a HpaI gene derived from Escherichia coli as a 4,6-dihydroxy-2-oxo-hexanoate aldolase, a HpcG gene derived from Escherichia coli as a 4,6-dihydroxy-2-oxo-hexanoate 4-dehydratase, a NADPH-dependent oxidoreductase 2-alkenal reductase (GenBank: CAC01710.1) gene derived from Arabidopsis (Arabidopsis thaliana) as a 6-hydroxy-3,4-dehydro-2-oxohexanoate 3-reductase, a PanE gene of Lactococcus lactis as a 6-hydroxy-2-oxohexanoate 2-reductase, and a HadA gene derived from Clostridium difficile as a 2,6-dihydroxy-hexanoate CoA-transferase and a 6-hydroxyhexanoyl CoA-transferase were introduced into BamHI and EcoRI restriction enzyme recognition sites of a multiple cloning site (MCS) of pUC19 (Nippon Gene Co., Ltd.) was constructed.

A plasmid C in which HadB and HadC genes derived from Clostridium difficile as α- and β-subunits of a 2-hydroxyisocaproyl-CoA dehydratase, a HadI gene derived from Clostridium difficile as an activator of a 2-hydroxyisocaproyl-CoA dehydratase, a trans-2-enoyl-CoA reductase (GenBank: AE017248) gene derived from Treponema denticola as a 6-hydroxy-2,3-dehydro-hexanoyl-CoA 2,3-reductase, a carboxylate reductase (GenBank: AAR91681.1) gene derived from Nocardia iowensis as a 6-hydroxyhexanoate 1-reductase, and a 6-hydroxyhexanoate dehydrogenase (GenBank: AAN37489.1) gene derived from the genus Rhodococcus as a 6-hydroxyhexanal 1-reductase were introduced into pCOLADuet-1 (Merck), HadB, HadC, and HadI genes were introduced into MCS1, and other genes were introduced into MCS2 was constructed.

The “gene” in this section refers to an open reading frame containing a termination codon encoding each enzyme. Each gene is introduced into a plasmid so that a sequence containing a T7 promoter and a ribosome binding site are present on the upstream and a sequence containing a T7 terminator is present on the downstream. Each gene can be overexpressed in such an Escherichia coli host strain that a T7RNA polymerase is expressed by appropriate induction of expression.

With the plasmids A, B, and C, chemically competent cells BL21 Star (DE3) (Invitrogen) were transformed in turn by the heat-shock method, and selected on an LB plate containing an appropriate antibiotic. As a result, a BL21 Star (DE3) strain containing all the plasmids A, B, and C was obtained.

Thus, Escherichia coli having genes encoding ten enzymes in 1,6-hexanediol pathways including a 4,6-dihydroxy-2-oxo-hexanoate aldolase (2A in the drawing of Japanese Patent No. 6680671), a 4,6-dihydroxy-2-oxo-hexanoate 4-dehydratase (2B in the drawing of Japanese Patent No. 6680671), a 6-hydroxy-3,4-dehydro-2-oxohexanoate 3-reductase (2C in the drawing of Japanese Patent No. 6680671), a 6-hydroxy-2-oxohexanoate 2-reductase (2D in the drawing of Japanese Patent No. 6680671), a 2,6-dihydroxy-hexanoate CoA-transferase (2E in the drawing of Japanese Patent No. 6680671), a 2,6-dihydroxy-hexanoyl-CoA 2-dehydratase (2F in the drawing of Japanese Patent No. 6680671), a 6-hydroxy-2,3-dehydro-hexanoyl-CoA 2,3-reductase (2G in the drawing of Japanese Patent No. 6680671), a 6-hydroxyhexanoyl-CoA-transferase (4F3 in the drawing of Japanese Patent No. 6680671), a 6-hydroxyhexanoate 1-reductase (5R in the drawing of Japanese Patent No. 6680671), and a 6-hydroxyhexanal 1-reductase (5S in the drawing of Japanese Patent No. 6680671) was created.

### Production Example 2: Preparation of 1,6-Hexanediol Composition 1 (1,6-HD Composition 1)

The Escherichia coli was inoculated into a medium sterilized in an autoclave (carbon source: glucose and glycerin, nitrogen source: enzyme extract, inorganic salt: potassium phosphate and potassium hydroxide, vitamin B12, antibiotic: carbenicillin, kanamycin, and chloramphenicol, pH: 7.0, of the components, glucose and glycerin are raw materials derived from biomass resources), and cultivated at 30° C. for 2 to 3 hours under an aerobic condition. After that, when the optical density at 600 nm of the Escherichia coli reached 0.3 to 0.6, isopropyl-β-thiogalactopyranoside and iron (II) sulfate were added so that a final concentration was 0.5 mM and 10 μM, respectively, and cultivation was further performed at 30° C. for 3 hours to express an enzyme for a 1,6-HD pathway. After the expression, a proper amount of the carbon source (glucose and glycerin) was added to create a nitrogen atmosphere in the incubator, achieving an anaerobic condition. Under this condition, cultivation was performed at 30° C. for 48 hours to produce 1,6-hexanediol (Step (1)). The culture medium was centrifuged at 4° C. for 20 minutes, the supernatant was collected and then filtered through a membrane filter having an appropriate pore size of 0.2 to 0.4 μm to obtain a 1,6-hexanediol composition as a filtrate.

### Purification of 1,6-Hexanediol Composition

### Step (a): Ion Exchange for Removing Cations

Cations contained in the 1,6-hexanediol composition were removed. In step (a), cation exchange was performed by a batch process. A temperature at which the composition was brought into contact with a cation-exchange resin was set to 40° C., and DIAION SK1BH manufactured by Mitsubishi Chemical Corporation was added as the cation-exchange resin to the 1,6-hexanediol composition, and stirred for 3 hours. After stirring, filtration was performed to obtain a 1,6-hexanediol composition A as a filtrate.

### Step (b): Ion Exchange for Removing Anions

Anions contained in the 1,6-hexanediol composition A were removed. In step (b), anion exchange was performed by a batch process. A temperature at which the composition was brought into contact with an anion-exchange resin was set to 40° C., and DIAION SA10AOH manufactured by Mitsubishi Chemical Corporation was added as the anion-exchange resin to the 1,6-hexanediol composition, and stirred for 3 hours. After stirring, filtration was performed to obtain a 1,6-hexanediol composition B as a filtrate.

### Step (c): Step of Removing Water

Water contained in the 1,6-hexanediol composition was removed. As an apparatus for step (c), a thin-film distillation apparatus was used. A jacket temperature was set to 70° C., a 1,6-hexanediol-containing composition was continuously introduced, and water was distilled from the top of the apparatus. At the same time as the distillation of water, a dehydrated 1,6-hexanediol composition C was continuously drawn as a fermenter effluent from the bottom. The water concentration in this 1,6-hexanediol composition C was 0.020 mass % (200 mass ppm).

### Step (d): Distillation Separation of Component Having Lower Boiling Point

A component having a lower boiling point than 1,6-hexanediol contained in the 1,6-hexanediol composition C was removed in a continuous distillation column. As a distillation column for step (d), an Oldershaw distillation column was used. The 1,6-hexanediol composition C obtained in step (c) was continuously supplied to the distillation column, and a column top temperature was controlled to a constant temperature of 240° C. Continuous distillation from the column top was performed, and continuous drawing from the column bottom was performed to remove the component having a lower boiling point in the 1,6-hexanediol composition C. A 1,6-hexanediol composition D obtained by removing the component having a lower boiling point than 1,6-hexanediol was collected from the column bottom.

### Step (e): Distillation Separation of Component Having Higher Boiling Point

A component having a higher boiling point than 1,6-hexanediol contained in the 1,6-hexanediol composition D was removed in a continuous distillation column. As a distillation column for step (e), an Oldershaw distillation column was used. The 1,6-hexanediol composition D obtained in step (d) was continuously supplied to the distillation column, and a column bottom temperature was controlled so as to be constant at 260° C. Continuous drawing from the column bottom was performed to remove the component having a higher boiling point in the 1,6-hexanediol composition D. A 1,6-hexanediol composition E obtained by removing the component having a higher boiling point than 1,6-hexanediol (1,6-HD composition 1) was collected from the column top (column top distillate).

The analysis results of the collected 1,6-HD composition 1 are listed below. In the analysis of the 1,6-HD composition, the detection limits of glycerin, glucose, 1,3-cyclohexanediol, 1,4-cyclohexanediol, and 6-hydroxyhexanal were 5.0 mass ppm, 5.0 mass ppm, 5.0 mass ppm, 5.0 mass ppm, and 10.0 mass ppm, respectively. Glycerin: 800 mass ppm
Glucose: detection limit or less
1,3-Cyclohexanediol: detection limit or less
1,4-Cyclohexanediol: detection limit or less
6-Hydroxyhexanal: 500 mass ppm

### Production Example 3: Preparation of 1,6-Hexanediol Composition 2 (1,6-HD Composition 2)

Purification of a 1,6-hexanediol composition obtained by a bio process in Production Example 2 was repeated to obtain a 1,6-hexanediol composition 2 having a glycerin content of 150 mass ppm and a 6-hydroxyhexanal content of 100 mass ppm.

The analysis results of the obtained 1,6-HD composition 2 are listed below.
Glycerin: 150 mass ppm
Glucose: detection limit or less
1,3-Cyclohexanediol: detection limit or less
1,4-Cyclohexanediol: detection limit or less
6-Hydroxyhexanal: 100 mass ppm

### Production Example 4: Preparation of 1,6-Hexanediol Composition 3 (1,6-HD Composition 3)

Purification of a 1,6-hexanediol composition obtained by a bio process in Production Example 2 was repeated to obtain a 1,6-hexanediol composition 3 having a glycerin content of 5 mass ppm and a 6-hydroxyhexanal content of 10 mass ppm.

The analysis results of the obtained 1,6-HD composition 3 are listed below.
Glycerin: 5 mass ppm
Glucose: detection limit or less
1,3-Cyclohexanediol: detection limit or less
1,4-Cyclohexanediol: detection limit or less
6-Hydroxyhexanal: 10 mass ppm

### Production Example 5: Preparation of 1,6-Hexanediol Composition 4 (1,6-HD Composition 4)

Glycerin was added to the 1,6-HD composition 3 obtained in Production Example 4 so that the content of glycerin was 150 mass ppm, to prepare a 1,6-hexanediol composition 4 (1,6-HD composition 4).

### Production Example 6: Preparation of 1,6-Hexanediol Composition 5 (1,6-HD Composition 5)

1,3-Cyclohexanediol was added to the 1,6-HD composition 3 obtained in Production Example 4 so that the content of 1,3-cyclohexanediol was 100 mass ppm, to prepare a 1,6-hexanediol composition 5 (1,6-HD composition 5).

### Production Example 7: Preparation of 1,6-Hexanediol Composition 6 (1,6-HD Composition 6)

1,4-Cyclohexanediol was added to the 1,6-HD composition 3 obtained in Production Example 4 so that the content of 1,4-cyclohexanediol was 100 mass ppm, to prepare a 1,6-hexanediol composition 6 (1,6-HD composition 6).

### Production Example 8: Preparation of 1,6-Hexanediol Composition 7 (1,6-HD Composition 7)

6-Hydroxyhexanal was added to the 1,6-HD composition 3 obtained in Production Example 4 so that the content of 6-hydroxyhexanal was 1, 500 mass ppm, to prepare a 1,6-hexanediol composition 7 (1,6-HD composition 7).

### Production Example 9: Preparation of 1,6-Hexanediol Composition 8 (1,6-HD Composition 8)

Glycerin was added to the 1,6-HD composition 3 obtained in Production Example 4 so that the content of glycerin was 1%, to prepare a 1,6-hexanediol composition 8 (1,6-HD composition 8).

### Example 1: Preparation of 1,6-Hexanediol Diglycidyl Ether Composition (HDG Composition 1)

Into a reaction vessel equipped with a stirrer, a temperature sensor, a decanter, a nitrogen inlet tube, and a condenser, 547.2 g (4.63 mol) of the 1,6-hexanediol composition 1 obtained in Production Example 2 and 1.0 g of boron trifluoride diethyl ether complex as a catalyst were put under a nitrogen atmosphere. The mixture was heated to 70° C. with stirring, 856.6 g (9.26 mol) of epichlorohydrin was added dropwise at the same temperature over 3 hours, and an addition reaction was then continued at the same temperature for 1 hour. Subsequently, 2800.0 g of toluene was added, the mixture was cooled to 30° C. with mixing and stirring, and 810.3 g of an aqueous solution of 48% sodium hydroxide was then added dropwise at the same temperature over 1 hour. After the addition, a cyclization reaction was performed at the same temperature for 1 hour. 1, 400.0 g of ion-exchanged water was added and stirred for 1 hour, the mixture was allowed to stand, and an aqueous phase was removed. After that, 700.0 g of ion-exchanged water was added and stirred for 1 hour, the mixture was allowed to stand, and an aqueous phase was removed. 700.0 g of ion-exchanged water was further added and mixed and stirred for 30 minutes, and sodium hypophosphite was added until the pH was 7 or less. After a pH of 7 or less was recognized, the mixture was allowed to stand, and an aqueous phase was removed. The decanter was set, the temperature was increased to 120° C. with stirring the mixture, and dehydration was performed until water was not released. After completion of deposition of water, the temperature was decreased to 60° C., and filtration and purification were performed at the same temperature using diatomaceous earth. From the obtained HDG toluene solution, toluene was distilled off at 120° C. under reduced pressure to obtain 1,000.0 g of a 1,6-hexanediol diglycidyl ether composition (HDG composition 1). The HDG composition 1 contained an oligomer component of HDG, and the content of 1,6-hexanediol diglycidyl ether (HDG) in 100 mass % of the HDG composition 1 was 75 mass %.

The analysis results of the obtained HDG composition 1 are listed below. In the analysis of the HDG composition, the detection limits of glycerin triglycidyl ether (GTG), glucose pentaglycidyl ether (GPG), 1,3-cyclohexanediol diglycidyl ether (1,3CDG), 1,4-cyclohexanediol diglycidyl ether (1,4CDG), and 6-(oxiran-2-ylmethoxy) hexanal (OHL) were 5.0 mass ppm, 5.0 mass ppm, 5.0 mass ppm, and 10.0 mass ppm, respectively.
Glycerin triglycidyl ether (GTG): 800 mass ppm
Glucose pentaglycidyl ether (GPG): detection limit or less
1,3-Cyclohexanediol diglycidyl ether (1,3CDG): detection limit or less
1,4-Cyclohexanediol diglycidyl ether (1,4CDG): detection limit or less
6-(Oxiran-2-ylmethoxy) hexanal (OHL): 500 mass ppm

### Examples 2 to 8: Preparation of 1,6-Hexanediol Diglycidyl Ether Compositions 2 to 8 (HDG Compositions 2 to 8)

HDG compositions 2 to 8 were prepared by the same operation as in Example 1 except that 1,6-HD compositions 2 to 8, respectively, were used instead of the 1,6-HD composition 1 used in Example 1. The synthesis results are listed in Table 1.

TABLE 1

| | Example | Example | Example | Example | Example | Example | Example | Example |
|---|---|---|---|---|---|---|---|---|
| | 1 | 2 | 3 | 4 | 5 | 6 | 7 | 8 |
| Name of HDG | HDG | HDG | HDG | HDG | HDG | HDG | HDG | HDG |
| composition | compo- | compo- | compo- | compo- | compo- | compo- | compo- | compo- |
| | sition 1 | sition 2 | sition 3 | sition 4 | sition 5 | sition 6 | sition 7 | sition 8 |
| Used 1,6-HD | 1,6-HD | 1,6-HD | 1,6-HD | 1,6-HD | 1,6-HD | 1,6-HD | 1,6-HD | 1,6-HD |
| composition | compo- | compo- | compo- | compo- | compo- | compo- | compo- | compo- |
| | sition 1 | sition 2 | sition 3 | sition 4 | sition 5 | sition 6 | sition 7 | tsiion 8 |
| GTG (ppm) | 800 | 150 | 5 | 150 | 5 | 5 | 5 | 10,000 |
| GPG¹⁾ (ppm) | ND | ND | ND | ND | ND | ND | ND | ND |
| 1,3CDG¹⁾ | ND | ND | ND | ND | 100 | ND | ND | ND |
| (ppm) | | | | | | | | |
| 1,4CDG¹⁾ | ND | ND | ND | ND | ND | 100 | ND | ND |
| (ppm) | | | | | | | | |
| OHL²⁾ (ppm) | 500 | 100 | 10 | 10 | 10 | 10 | 1,500 | 10 |
| Total | ND | ND | ND | ND | 100 | 100 | ND | ND |
| content of | | | | | | | | |
| compound | | | | | | | | |
| (A1) and | | | | | | | | |
| compound | | | | | | | | |
| (A2) (ppm) | | | | | | | | |
| Total | 500 | 100 | 10 | 10 | 10 | 10 | 1,500 | 10 |
| content of | | | | | | | | |
| compound | | | | | | | | |
| (B1) and | | | | | | | | |
| compound | | | | | | | | |
| (B2) (ppm) | | | | | | | | |
| Content of | 75 | 76 | 77 | 76 | 76 | 76 | 74 | 72 |
| HDG (mass %) | | | | | | | | |

¹⁾a glycidyl ether compound of a compound having two or more secondary hydroxy groups in one molecule
²⁾a glycidyl ether compound of 6-hydroxyhexanal

### Production Example 9: Production and Evaluation of Curable Composition 1

20.0 g of the 1,6-hexanediol diglycidyl ether composition (HDG composition 1) obtained in Example 1, 80.0 g of EPICLON 850 (bisphenol A type liquid epoxy resin) manufactured by DIC Corporation, and 48.7 g of LUCKAMIDE WN-215 (Mannich type polyamine resin curing agent) manufactured by DIC Corporation were mixed to obtain a curable composition 1.

A specimen of a cured product as described below was prepared by using the curable composition 1 and evaluated.

### <Shore D Hardness>

The above-mentioned curable composition was poured into an aluminum petri dish so that the film thickness of a cured product was 7 mm, and aged at 23° C. for 7 days to obtain the cured product. The Shore D hardness of the cured product was measured and evaluated with a type D durometer hardness tester in accordance with JIS K7215-1986.

### <Tensile Test>

The above-mentioned curable composition was poured into a prepared glass vessel so that the thickness of a cured product was 3 mm, and aged at 23° C. for 7 days to obtain the cured product. The obtained cured product was cut in a shape of dumbbell No. 1 to obtain a specimen, and the specimen was subjected to a tensile test in accordance with JIS K6911. The maximum point stress, the elongation, and the elastic modulus recognized in the test were evaluated as indications of tensile strength, flexibility, and hardness, respectively.

### <Compression Test>

The above-mentioned curable composition was poured into a vessel capable of creating a cube with a side of 20 mm, and aged at 23° C. for 7 days to prepare a specimen of the same cube. The specimen was subjected to a compression test in accordance with JIS K6911. Compressive strength was evaluated by the obtained maximum point stress and elastic modulus.

### <Bending Test>

The above-mentioned curable composition was poured into a vessel capable of creating a rectangular parallelepiped of 10 mm×100 mm, and aged at 23° C. for 7 days to prepare a specimen of the same rectangular parallelepiped. The specimen was subjected to a bending test in accordance with JIS K7171. Bending strength was evaluated by the obtained maximum point stress and elastic modulus.

### Production Examples 10 to 16: Production and Evaluation of Curable Compositions 2 to 8

Curable compositions were prepared in the same manner as in Production Example 9 except that a blending composition was changed from the blending composition of Production Example 9 to a blending composition listed in Table 2, and evaluated in the same manner as in Production Example 9.

TABLE 2

| | | Produc- | Produc- | Produc- | Produc- | Produc- | Produc- | Produc- | Produc- |
|---|---|---|---|---|---|---|---|---|---|
| | | tion | tion | tion | tion | tion | tion | tion | tion |
| | | Example | Example | Example | Example | Example | Example | Example | Example |
| | | 9 | 10 | 11 | 12 | 13 | 14 | 15 | 16 |
| Name of curable | | Curable | Curable | Curable | Curable | Curable | Curable | Curable | Curable |
| composition | | compo- | compo- | compo- | compo- | compo- | compo- | compo- | compo- |
| | | sition | sition | sition | sition | sition | sition | sition | sition |
| | | 1 | 2 | 3 | 4 | 5 | 6 | 7 | 8 |
| Used HDG | | HDG | HDG | HDG | HDG | HDG | HDG | HDG | HDG |
| composition | | compo- | compo- | compo- | compo- | compo- | compo- | compo- | compo- |
| | | sition | sition | sition | sition | sition | sition | sition | sition |
| | | 1 | 2 | 3 | 4 | 5 | 6 | 7 | 8 |
| Blending amount | | 20.0 | 10.0 | 30.0 | 30.0 | 20.0 | 20.0 | 20.0 | 20.0 |
| of HDG | | | | | | | | | |
| composition | | | | | | | | | |
| 850 | | 80.0 | | 70.0 | 70.0 | 80.0 | 80.0 | | 80.0 |
| 830 | | | 90.0 | | | | | 80.0 | |
| WN215 | | 48.7 | 49.8 | 49.9 | 49.9 | | | | 48.7 |
| WN505 | | | | | | | | 33.5 | |
| WH610 | | | | | | 50.4 | | | |
| EA330 | | | | | | | 42.6 | | |
| Shore D hardness | | 82 | 74 | 70 | 75 | 81 | 67 | 73 | 93 |
| Tensile | Maximum | 78 | 75 | 70 | 80 | 98 | 58 | 95 | 91 |
| test | point | | | | | | | | |
| | stress | | | | | | | | |
| | (MPa) | | | | | | | | |
| | Elonga- | 5 | 8 | 9 | 8 | 6 | 6 | 8 | 5 |
| | tion (%) | | | | | | | | |
| | Elastic | 3,530 | 3,420 | 3,250 | 3,360 | 3,510 | 2,860 | 3,300 | 3,740 |
| | modulus | | | | | | | | |
| | (MPa) | | | | | | | | |
| Com- | Maximum | 100 | 97 | 93 | 103 | 121 | 78 | 118 | 111 |
| pression | point | | | | | | | | |
| test | stress | | | | | | | | |
| | (MPa) | | | | | | | | |
| | Elastic | 2,590 | 2,480 | 2,390 | 2,470 | 2,590 | 1,460 | 2,710 | 2,780 |
| | modulus | | | | | | | | |
| | (MPa) | | | | | | | | |
| Bending | Maximum | 103 | 98 | 90 | 100 | 125 | 89 | 119 | 112 |
| test | point | | | | | | | | |
| | stress | | | | | | | | |
| | (MPa) | | | | | | | | |
| | Elastic | 3,220 | 3,150 | 3,100 | 3,250 | 3,410 | 2,780 | 3,200 | 3,350 |
| | modulus | | | | | | | | |
| | (MPa) | | | | | | | | |

The components of Table 2 are as described below.
850: EPICLON 850 (bisphenol A type liquid epoxy resin, epoxy equivalent=190 g/eq) manufactured by DIC Corporation
830: EPICLON 830 (bisphenol F type liquid epoxy resin, epoxy equivalent=180 g/eq) manufactured by DIC Corporation
WN215: LUCKAMIDE WN-215 (Mannich type polyamine resin curing agent, active hydrogen equivalent-88 g/eq) manufactured by DIC Corporation
WN505: LUCKAMIDE WN-505 (amine adduct type polyamine resin curing agent, active hydrogen equivalent=58 g/eq) manufactured by DIC Corporation
WH610: LUCKAMIDE WH-610 (modified amine type polyamine resin curing agent, active hydrogen equivalent=91 g/eq) manufactured by DIC Corporation
EA330: LUCKAMIDE EA-330 (polyamide type polyamine resin curing agent, active hydrogen equivalent=77 g/eq) manufactured by DIC Corporation

### Comparative Production Example 1: Preparation of 1,6-Hexanediol Composition 9 (1,6-HD Composition 9)

Glucose was added to the 1,6-HD composition 3 obtained in Production Example 4 so that the content of glucose was 150 mass ppm, to prepare a 1,6-hexanediol composition 9 (1,6-HD composition 9).

### Comparative Production Example 2: Preparation of 1,6-Hexanediol Composition 10 (1,6-HD Composition 10)

1,3-Cyclohexanediol was added to the 1,6-HD composition 3 obtained in Production Example 3 so that the content of 1,3-cyclohexanediol was 150 mass ppm, to prepare a 1,6-hexanediol composition 10 (1,6-HD composition 10).

### Comparative Production Example 3: Preparation of 1,6-Hexanediol Composition 11 (1,6-HD Composition 11)

1,4-Cyclohexanediol was added to the 1,6-HD composition 3 obtained in Production Example 3 so that the content of 1,4-cyclohexanediol was 150 mass ppm, to prepare a 1,6-hexanediol composition 11 (1,6-HD composition 11).

### Comparative Examples 1 to 3: Preparation of 1,6-Hexanediol Diglycidyl Ether Compositions 9 to 11 (HDG Compositions 9 to 11)

HDG compositions 9 to 11 were prepared by the same operation as in Example 1 except that 1,6-HD compositions 9 to 11, respectively, were used instead of the 1,6-HD composition 1 used in Example 1. The synthesis results are listed in Table 3.

TABLE 3

| | Comparative | Comparative | Comparative |
|---|---|---|---|
| | Example 1 | Example 2 | Example 3 |
| Name of HDG composition | HDG | HDG | HDG |
| | composition 9 | composition 10 | composition 11 |
| Used 1,6-HD composition | 1,6-HD | 1,6-HD | 1,6-HD |
| | composition 9 | composition 10 | composition 11 |
| GTG (ppm) | 5 | 5 | 5 |
| GPG (ppm) | 150 | ND | ND |
| 1,3CDG (ppm) | ND | 150 | ND |
| 1,4CDG (ppm) | ND | ND | 150 |
| OHL (ppm) | 10 | 10 | 10 |
| Total content of compound | 150 | 150 | 150 |
| (A1) and compound (A2) (ppm) | | | |
| Total content of compound | 10 | 10 | 10 |
| (B1) and compound (B2) (ppm) | | | |
| Content of HDG (mass %) | 74 | 75 | 75 |

### Comparative Production Examples 4 to 8: Production and Evaluation of Curable Compositions 9 to 13

Curable compositions were prepared in the same manner as in Production Example 9 except that a blending composition was changed from the blending composition of Production Example 9 to a blending composition listed in Table 4, and evaluated in the same manner as in Production Example 9.

TABLE 4

| | | Comparative | Comparative | Comparative | Comparative | Comparative |
|---|---|---|---|---|---|---|
| | | Production | Production | Production | Production | Production |
| | | Example 4 | Example 5 | Example 6 | Example 7 | Example 8 |
| Name of curable | | Curable | Curable | Curable | Curable | Curable |
| composition | | composi- | composi- | composi- | composi- | composi- |
| | | tion 9 | tion 10 | tion 11 | tion 12 | tion 13 |
| Used HDG composition | | HDG | HDG | HDG | HDG | HDG |
| | | Composi- | Composi- | Composi- | Composi- | Composi- |
| | | tion 9 | tion 9 | tion 10 | tion 10 | tion 11 |
| Blending amount of HDG | | 20.0 | 10.0 | 30.0 | 20.0 | 20.0 |
| composition | | | | | | |
| 850 | | 80.0 | | 70.0 | 80.0 | 80.0 |
| 830 | | | 90.0 | | | |
| WN215 | | 48.7 | 49.8 | 49.9 | | |
| WN505 | | | | | 32.1 | 32.1 |
| Shore D hardness | | 72 | 67 | 60 | 63 | 62 |
| Tensile | Maximum point | 65 | 50 | 45 | 45 | 46 |
| test | stress (MPa) | | | | | |
| | Elongation | 2 | 6 | 9 | 9 | 9 |
| | (%) | | | | | |
| | Elastic | 3,030 | 2,810 | 2,650 | 2,650 | 2,660 |
| | modulus (MPa) | | | | | |
| Compression | Maximum point | 85 | 77 | 73 | 73 | 72 |
| test | stress (MPa) | | | | | |
| | Elastic | 2,090 | 1,980 | 1,890 | 1,890 | 1,900 |
| | modulus (MPa) | | | | | |
| Bending | Maximum point | 88 | 81 | 75 | 75 | 76 |
| test | stress (MPa) | | | | | |
| | Elastic | 2,720 | 2,610 | 2,400 | 2,400 | 2,410 |
| | modulus (MPa) | | | | | |

From Examples and Comparative Examples described above, it was seen that the composition of hexanediol glycidyl ether and/or an oligomer thereof of the present invention that contains hexanediol glycidyl ether and/or an oligomer thereof, and in which the total content of a compound having two or more secondary hydroxy groups in one molecule (A1) and a glycidyl ether compound (A2) of the compound (A1) is 100 mass ppm or less, and the total content of 6-hydroxyhexanal and a derivative thereof (B1) and a glycidyl ether compound (B2) of the compound (B1) is 1,500 mass ppm or less can provide a cured product having excellent physical properties (particularly tensile strength, hardness, compressive strength, and bending strength).

1. A composition of hexanediol glycidyl ether and/or an oligomer thereof comprising hexanediol glycidyl ether and/or an oligomer thereof, wherein
a total content of a compound having two or more secondary hydroxy groups in one molecule (A1) and a glycidyl ether compound (A2) of the compound (A1) is 100 mass ppm or less, and
a total content of 6-hydroxyhexanal and a derivative thereof (B1) and a glycidyl ether compound (B2) of the compound (B1) is 1,500 mass ppm or less.

2. The composition of hexanediol glycidyl ether and/or an oligomer thereof according to claim 1, wherein the compound (A2) is at least one compound selected from the group consisting of a glycidyl ether of glucose (a compound represented by the following formula (A2-1)), a glycidyl ether of 1,4-cyclohexanediol (a compound represented by the following formula (A2-2)), a glycidyl ether of 1,2-cyclohexanediol (a compound represented by the following formula (A2-3)), and a glycidyl ether of 1,3-cyclohexanediol (a compound represented by the following formula (A2-4)): 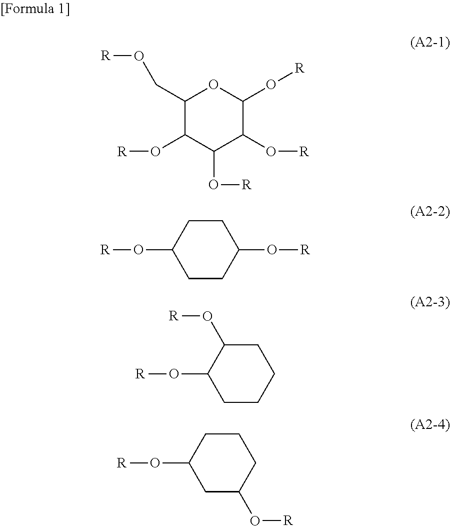
in the formulae (A2-1) to (A2-4), Rs are same or different from each other, and each represent a hydrogen atom or a glycidyl group, provided that at least one R is a glycidyl group.

3. The composition of hexanediol glycidyl ether and/or an oligomer thereof according to claim 1, wherein the compound (B2) is at least one compound selected from the group consisting of compounds represented by the following formulae (B2-1) to (B2-7): 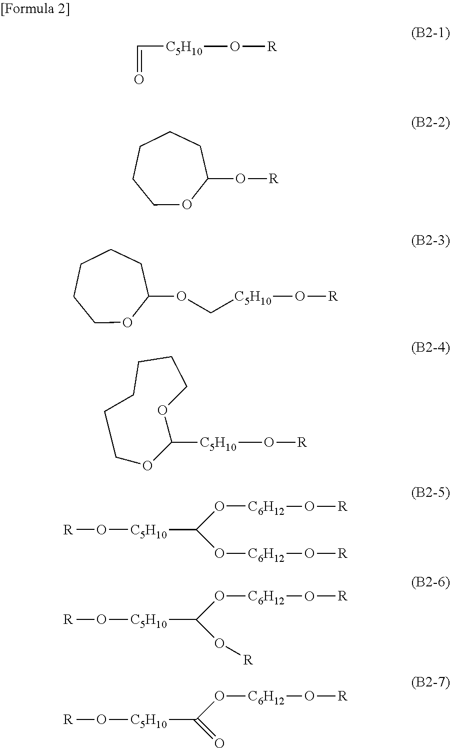
in the formulae (B2-1) to (B2-7), Rs are the same or different from each other, and each represent a hydrogen atom or a glycidyl group, provided that at least one R is a glycidyl group.

4. The composition of hexanediol glycidyl ether and/or an oligomer thereof according to claim 1, comprising a glycidyl ether of glycerin (a compound represented by the following formula (C)): 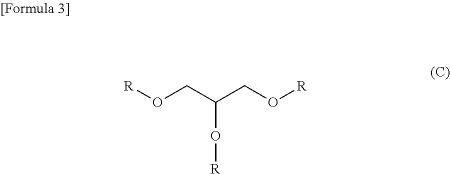
in the formula (C), Rs are the same or different from each other, and each represent a hydrogen atom or a glycidyl group, provided that at least one R is a glycidyl group.

5. The composition of hexanediol glycidyl ether and/or an oligomer thereof according to claim 1, wherein the composition is prepared from a 1,6-hexanediol composition derived from biomass resources.

6. A curable composition comprising the composition of hexanediol glycidyl ether and/or an oligomer thereof according to claim 1.

7. The curable composition according to claim 6, comprising an epoxy resin other than the composition of hexanediol glycidyl ether and/or an oligomer thereof.

8. The curable composition according to claim 7, wherein the epoxy resin other than the composition of hexanediol glycidyl ether and/or an oligomer thereof is a bisphenol F type epoxy resin.

9. The curable composition according to claim 7, wherein the epoxy resin other than the composition of hexanediol glycidyl ether and/or an oligomer thereof is a bisphenol A type epoxy resin.

10. The curable composition according to claim 6, comprising a polyamine compound.

11. The curable composition according to claim 6, comprising an acid anhydride.

12. The curable composition according to claim 6, comprising a phenolic hydroxy group-containing resin.

13. The curable composition according to claim 6, wherein the curable composition is used in at least one application selected from the group consisting of an ink, a coating, a paint, an adhesive, and a crack repair agent.

14. A cured product obtained by curing the curable composition according to claim 6.

15. The curable composition comprising the composition of hexanediol glycidyl ether and/or an oligomer thereof according to claim 2.

16. The curable composition comprising the composition of hexanediol glycidyl ether and/or an oligomer thereof according to claim 3.

17. The curable composition comprising the composition of hexanediol glycidyl ether and/or an oligomer thereof according to claim 4.

18. The curable composition comprising the composition of hexanediol glycidyl ether and/or an oligomer thereof according to claim 5.

19. The curable composition according to claim 15, comprising an epoxy resin other than the composition of hexanediol glycidyl ether and/or an oligomer thereof.

20. The curable composition according to claim 19, wherein the epoxy resin other than the composition of hexanediol glycidyl ether and/or an oligomer thereof is a bisphenol F type epoxy resin.
